(19) United States
(12) Patent Application Publication
(10) Pub. No.: US 2023/0152273 A1
(43) Pub. Date: May 18, 2023

(54) Electrophoresis Device and Analysis Method

(71) Applicant: Hitachi High-Tech Corporation, Minato-ku, Tokyo (JP)

(72) Inventors: Noriyuki SUMIDA, Tokyo (JP); Michiru FUJIOKA, Tokyo (JP); Motohiro YAMAZAKI, Tokyo (JP); Isao HARAURA, Tokyo (JP); Yoshimasa MOMOSE, Tokyo (JP); Masateru KUMAGAI, Tokyo (JP)

(21) Appl. No.: 17/918,050

(22) PCT Filed: May 12, 2020
(86) PCT No.: PCT/JP2020/019033

§ 371 Date: Oct. 10, 2022

(51) Int. Cl. G01N 27/447; G01N 21/64

(52) U.S. Cl. CPC G01N 27/44704; G01N 21/6428

(57) ABSTRACT

An electrophoresis device of the present disclosure includes an electrophoresis path of a sample, a dispersion element for dispersing light from the sample within the electrophoresis path, a photodetector for detecting the light dispersed by the dispersion element, and a computation unit for determining a spectrum of the light on the basis of a signal from the photodetector, and is characterized in that the computation unit corrects the spectrum using correction factors determined for each migration condition or fluorescent dye.

### TECHNICAL FIELD

The present disclosure relates to an electrophoresis device and an analysis method.

### BACKGROUND ART

As a method for analyzing the base sequence or the base length of a DNA, an electrophoresis method is known widely. As one of the analysis method using electrophoresis, there is capillary electrophoresis. The capillary electrophoresis is a technology where a fine tube called a capillary is filled with a separation medium such as acrylamide to perform electrophoresis. To be more specific, when a sample including a DNA is disposed at one end of the capillary and a high voltage is applied to both ends of the capillary in the state, the DNA that is a charged particle negatively charged moves to the positive pole side inside the capillary depending on own size namely the base length. Also, by measuring time required for the sample to migrate through a constant distance (from a sample poring end of the capillary to a signal detection unit in normal cases), the base length of the DNA can be analyzed. Each DNA is labelled by a fluorescent dye, and fluorescence is produced by irradiation of excitation light. The fluorescence is detected by a photodetector.

In an analysis of the DNA by capillary electrophoresis, there is a case of using plural fluorescent dyes for the purpose of speeding up the analysis. The plural fluorescent dyes respectively produce different fluorescence receiving irradiation of excitation light. A spectrum obtained by dispersing this fluorescence and acquiring the same on a photodetector is called a fluorescence spectrum. Although each fluorescent dye has a different fluorescence spectrum respectively, they are not sharp, and the fluorescence spectra of respective fluorescent dyes overlap with each other. Therefore, in a photodetector, when DNA fragments labelled by a different fluorescent dye have a fragment length of a same degree, a fluorescence spectrum obtained by a photodetector becomes a linear sum namely a weighted sum of fluorescence spectra of plural kinds of the fluorescent dye. In order to obtain the signal strength (fluorescence strength) of each fluorescent dye from this state, a linear coefficient namely a weighted value of a spectrum of each fluorescent dye configuring a spectrum can be obtained from the spectrum obtained by a photodetector.

In order to obtain this weighted value, each fluorescence spectrum should be known in advance. Each fluorescence spectrum is to be intrinsically determined unitarily by a fluorescent dye and a separation medium without depending on a device. However, in an actual device, the fluorescence spectrum changes due to various reasons. One that is known well among them is the positional relation of a capillary and a photodetector. Therefore, when the capillary is to be replaced, before a sample of an analysis object (will be hereinafter expressed as an “actual sample”) is subject to electrophoresis, an operation of obtaining beforehand a fluorescence spectrum in the device and the capillary is required. This operation is called “spectral calibration”. Also, when electrophoresis is performed for plural samples simultaneously using a capillary array where plural capillaries are arrayed, it is required to obtain the fluorescence spectrum for each capillary.

Here, an example of the spectral calibration related to a prior art will be explained.

FIG. 1 is a diffraction grating image (bottom) imaged in a photodetector of a multi-capillary electrophoresis device, and a drawing (top) showing the signal strength distribution of a capillary corresponding to the A-A′ direction of the diffraction grating image. The multi-capillary electrophoresis device separates fluorescence emitted from each fluorescent dye by irradiating laser light having a specific wavelength to the capillary in the wavelength direction by a diffraction grating, and detects the separated light by a photodetector such as a CCD to acquire a diffraction grating image. Also, the signal strength distribution (spectrum) of the diffraction grating image is acquired.

The bottom of FIG. 1 is a diffraction grating image when laser light is irradiated to a capillary where four pieces of capillaries are arrayed, the vertical axis shows the sequence direction of the capillary, and the horizontal axis shows the wavelength direction. In the top of FIG. 1, the vertical axis shows the signal strength (brightness value (RFU)), and the horizontal axis shows the wavelength. Further, although FIG. 1 shows an example of measuring a spectrum continuously (discretely for each pixel in fact) using a diffraction grating, it may be data which are obtained by sampling the spectrum described above with a wide wavelength interval. For example, as illustrated in the diffraction grating image of FIG. 1, only the signal strength in the twenty wavelengths λ(0) to λ(19) may be acquired for each capillary. Also, an arithmetic mean of the signal strength in the vicinity of each of the wavelengths λ(0) to λ(19) may be taken.

FIG. 2 is a flowchart showing a spectral calibration method of a prior art.

In step S101, an operator performs electrophoresis of a matrix standard. The matrix standard is a reagent for acquiring a fluorescence spectrum and obtaining a matrix described below. The matrix standard includes four kinds of DNA fragments with different length respectively labeled by different fluorescent dye. Information of the length or the order of the length of the DNA fragment corresponding to each fluorescent dye is known.

FIG. 3A is a drawing showing a waveform of a signal strength obtained by performing electrophoresis of the matrix standard, the vertical axis shows the signal strength, and the horizontal axis shows the time. In step S101, it is assumed to obtain fluorescent spectra of four kinds of the fluorescent dye (ROX, TMR, R110, and R6G), and FIG. 3A shows a state of laying the signal strength waveform of each fluorescent dye on one graph. As shown in FIG. 3A, a sharp peak appears at a time corresponding to the length of the DNA fragment labeled by each fluorescent dye. Since the DNA fragment with different length is labeled respectively by a different fluorescent dye, each fluorescent dye produces light in isolation at each peak time (t0, t1, t2, and t3). Therefore, by acquiring a spectrum at the time when only a specific fluorescent dye produces light (t0, t1, t2, t3, and t4 in FIG. 3A), the fluorescence spectrum of each fluorescent dye is obtained.

Returning to FIG. 2, in step S102, a computation control circuit of the multi-capillary electrophoresis device calculates the fluorescence strength from the spectrum of each time of the signal strength obtained in step S101. Processing of the present step may be performed for each scanning time, and may be performed after accumulating spectrum data of a portion of a constant time interval.

In step S103, the computation control circuit detects the peak time of the signal strength waveform of FIG. 3A. As described above, since the appearance order of the peak corresponding to the length of the DNA fragment labeled by each fluorescent dye is known, the kind of the fluorescent dye can be identified by the appearance time of the peak. FIG. 3A shows the situations ROX produces light at time t0, TMR produces light at time t1, R110 produces light at time t2, and R6G produces light at time t3 in isolation respectively. The spectrum of each time corresponds to each fluorescence spectrum. That is to say, each fluorescence spectrum is known by acquiring the spectrum of each peak time.

FIG. 3B is the fluorescence spectrum acquired from the signal strength waveform of FIG. 3A, the vertical axis shows the fluorescence strength, and the horizontal axis shows the wavelength. As shown in FIG. 3B, the computation control circuit acquires the fluorescence spectrum of each fluorescent dye based on the signal strength waveform.

Returning to FIG. 2, in step S104, the computation control circuit acquires a matrix M using each fluorescence spectrum. The mathematical expression 1 described below shows an example of the matrix M of a case of acquiring the signal strength in the twenty wavelengths λ(0) to λ(19). The element of the matrix M corresponds to the strength ratio of the signal strength of each fluorescent dye at each time and in each wavelength. This ratio is a rate relative to a maximum value among the wavelength of each fluorescent dye for example. For example, an element WX1 of the mathematical expression 1 is a ratio of the fluorescence strength of the fluorescent dye ROX at the time t0 and the wavelength λ(1). It means that as this values is larger, contribution to the fluorescence strength of the wavelength is stronger. The matrix M is used to obtain each fluorescence strength from the spectrum waveform obtained by the photodetector.

$$\begin{matrix}\text{M =} \left[\begin{matrix}{W}_{X 0} & {W}_{X 1} & {W}_{X 2} \\ {W}_{T 0} & {W}_{T 1} & {W}_{T 2} \\ {W}_{R 0} & {W}_{R 1} & {W}_{R 2} \\ {W}_{G 0} & {W}_{G 1} & {W}_{G 2}\end{matrix} \cdot \cdot \cdot \cdot \cdot \cdot \cdot \begin{matrix}{W}_{X 18} & {W}_{X 19} \\ {W}_{T 18} & {W}_{T 19} \\ {W}_{R 18} & {W}_{R 19} \\ {W}_{G 18} & {W}_{G 19}\end{matrix}\right] \\ \begin{matrix}X ⇒ & \text{ROX} \\ T ⇒ & \text{TMR} \\ R ⇒ & \text{R110} \\ G ⇒ & \text{R6G}\end{matrix}\end{matrix}$$

The operation of step S101 to S104 described above is the spectral calibration. When there exist more than one of the capillaries, it is required to acquire the matrix M for each capillary. Also, it is required to perform the spectral calibration whenever the capillary is disposed, the component is replaced, and so on.

The matrix M obtained in the spectral calibration is also called a reference spectrum, and is identical to the fluorescence spectrum of an actual sample ideally. However, in practice, a deviation possibly occurs between the reference spectrum and the fluorescence spectrum of the actual sample. When the deviation occurs, a weighted value is not calculated correctly, and erroneous fluorescence strength is recorded. In a serious case, a pseudo peak appears at a peak time same as the time of the main peak.

FIG. 4 is a fluorescence spectrum when a pseudo peak appears. The pseudo peak possibly occurs by overlapping of the fluorescence spectrum of each color, and the effect by this overlapping is observed largely when a deviation occurs between the reference spectrum and the fluorescence spectrum of the actual sample. Also, when there are a plurality of the main peaks, this pseudo peak is observed in all of the main peaks.

The deviation between the reference spectrum and the fluorescence spectrum of the actual sample generally occurs due to the difference in the fluorescent dye and the electrophoresis condition between the time of the spectral calibration and the time of electrophoresis of the actual sample. That is to say, since the operator is required to repeat the spectral calibration whenever the fluorescent dye and the electrophoresis condition used for an actual sample are changed, the labor and the cost increase.

Patent Literature 1 discloses a gene analysis device that is “characterized by acquiring a reference fluorescence spectrum by using an allelic ladder and a size standard that is known information for a DNA fragment used in electrophoresis of an actual sample, and is characterized in that, on capillaries not using an allelic ladder, the spectral calibration is performed by detecting an amount of shift in the fluorescence spectrum of the size standard and calculating the fluorescence spectrum by shifting the reference fluorescence spectrum using the amount of shift” (refer to the abstract of the literature). Thus, since it is not required to perform electrophoresis using a special matrix standard, the spectral calibration can be achieved in a short time and at a low cost.

The size standard is a mixture of the known DNA fragments labeled by a specific fluorescent dye. The allelic ladder is a mixture of the known DNA fragments labeled by a fluorescent dye same as that of the actual sample. In an operation described in Patent Literature 1, the size standard is mixed for all samples at the time of electrophoresis. Also, the allelic ladder is analyzed by a capillary separate from that of the actual sample.

### Citation List

### Patent Literature

Patent Literature 1: JP-A No. 2014-117222

### SUMMARY OF INVENTION

### Technical Problem

However, in Patent Literature 1, the amount of shift of the fluorescence spectrum between the capillaries is calculated using a specific fluorescent dye, and such a case is not assumed that the amount of shift described above differs according to the fluorescent dye. Therefore, according to the fluorescent dye, there is a case that an appropriate reference spectrum is not obtained, a deviation occurs between the reference spectrum and the fluorescence spectrum of the actual sample, and a pseudo peak occurs. Also, in the example 3 of Patent Literature 1, an example of performing the spectral calibration for each capillary is cited. However, for that purpose, a peak formed of a fluorescent dye of a single color becomes necessary. Therefore, there is a case that a reference spectrum cannot be obtained in such sample that plural peaks overlap with each other. As a result, a deviation possibly occurs between the reference spectrum and the fluorescence spectrum of the actual sample. From the above, since the method of Patent Literature 1 is hardly applied to an optional fluorescent dye and an optional sample, it is required to repeat the spectral calibration whenever the electrophoresis condition and the fluorescent dye are changed. Therefore, the labor of the operator and the cost increase.

Therefore, the present disclosure provides an electrophoresis device and an analysis method reducing the labor of the operator and the cost.

### Solution to Problem

In order to solve the problem described above, an electrophoresis device of the present disclosure includes an electrophoresis path of a sample, a dispersion element for dispersing light from the sample within the electrophoresis path, a photodetector for detecting the light dispersed by the dispersion element, and a computation unit for determining the spectrum of the light on the basis of a signal from the photodetector, and is characterized in that the computation unit corrects the spectrum using correction factors determined for each electrophoresis condition or fluorescent dye.

Also, another electrophoresis device of the present disclosure includes an electrophoresis path of a sample, a dispersion element for dispersing light from the sample within the electrophoresis path, a photodetector for detecting the light dispersed by the dispersion element, and a computation unit for calculating signal strength of the light on the basis of a signal of the photodetector, and is characterized in that the photodetector acquires the signal with a signal acquisition width that is set so that a correlation coefficient between spectra of plural fluorescent dyes becomes equal to or greater than a predetermined value.

Other features related to the present disclosure will be clarified by description of the present description and the attached drawings. Also, aspects of the present disclosure will be achieved and actualized by elements and combination of various elements, detailed description hereinbelow, and aspects of the attached claims.

Description of the present description is only a typical exemplification, and does not limit the claims or the application example of the present disclosure in any means.

### Advantageous Effects of Invention

According to the present disclosure, it is not required to repeat the spectral calibration whenever the electrophoresis condition and the fluorescent dye are changed. As a result, the labor of the operator and the cost are reduced. Problems, configurations, and effects other than those described above will be clarified by explanation of embodiments described below.

### BRIEF DESCRIPTION OF DRAWINGS

FIG. 1 is a drawing showing the signal strength of fluorescence detected by a multi-capillary electrophoresis device (top) and the wavelength (bottom).

FIG. 2 is a flowchart showing a conventional spectral calibration method.

FIG. 3A is a drawing for explaining a summary of spectral calibration related to a prior art.

FIG. 3B is a drawing for explaining a summary of spectral calibration related to a prior art.

FIG. 4 is a drawing for explaining a pseudo peak.

FIG. 5 is a schematic view showing a multi-capillary electrophoresis device related to a first embodiment.

FIG. 6 is a schematic view showing a configuration of an optical system within a constant temperature reservoir.

FIG. 7 is a flowchart showing a calculation method of a correction factor related to the first embodiment.

FIG. 8A is a drawing for explaining a summary of calculation of a matrix M′ in the first embodiment.

FIG. 8B is a drawing for explaining a summary of calculation of a matrix M′ in the first embodiment.

FIG. 9 is a flowchart showing an application method of a correction factor in electrophoresis of an actual sample.

FIG. 10 is a flowchart of an electrophoresis method of an actual sample.

FIG. 11 is a drawing for explaining gauss fitting.

FIG. 12 is a flowchart showing an analysis method of a sample related to a second embodiment.

FIG. 13 is a drawing showing a result of an experiment example 1.

FIG. 14 is a flowchart showing an analysis method of a sample related to a third embodiment.

FIG. 15A is a drawing showing a fluorescent dye used in an experiment example 2.

FIG. 15B is a drawing showing a result of the experiment example 2.

FIG. 16 is a flowchart showing an analysis method of a sample related to a fifth embodiment.

FIG. 17A is a fluorescence spectrum acquired in an experiment example 3.

FIG. 17B is a fluorescence spectrum acquired in a control experiment of the experiment example 3.

FIG. 18 is a flowchart showing an analysis method of a sample related to a sixth embodiment.

### DESCRIPTION OF EMBODIMENTS

Embodiments will be hereinafter explained referring to the attached drawings. In the attached drawings, there is also a case of expressing an element having a same function by a same reference sign. Further, although the attached drawings show embodiments and implementation examples in line with the technical principle of the present disclosure, they are for the purpose of understanding of the present disclosure, and are not to be used by any means for interpreting the technology of the present disclosure in a limiting manner. Description of the present description is only a typical exemplification, and does not limit the claims or the application example of the present disclosure in any means.

In the present embodiments, although explanation thereof is made in detail to be sufficiently enough for a person with an ordinary skill in the art to implement the present disclosure, it is to be understood that other implementations and aspects are also possible and changing of the configuration and construction and replacement of various elements are possible without deviating from the scope and spirit of the technical thought of the present disclosure. Therefore, description below should not be interpreted to be limited to it.

### First Embodiment

As described in Background Art, when the deviation occurs between the reference spectrum and the fluorescence spectrum of the actual sample, a true weighted value is not calculated, and erroneous fluorescence strength is recorded. This deviation occurs mainly because the spectrum changes mainly by denaturalization of the fluorescent dye. Denaturalization of the fluorescent dye occurs by improper pH, storage at an improper temperature, and excessive excitation of the dye. Further, denaturalization of the fluorescent dye possibly occurs also when a migration voltage differs between the time of the spectral calibration and the time of migration of the actual sample. In an electrophoresis device including plural capillaries, since the excitation light strength differs in each capillary, a deviation possibly occurs. It is to be noted also that the degree of denaturalization differs according to the fluorescent dye in each example cited above. Further, even when the actual sample is labeled by a fluorescent dye different from the matrix standard, a deviation occurs as a matter of course.

Therefore, in the first embodiment, explanation will be given on operation of a case a migration voltage differs between the time of the spectral calibration by an operator having purchased the multi-capillary electrophoresis device and the time of migration of the actual sample (correction of the fluorescence spectrum. Also, in the present description, there is a case that spectral calibration implemented by a manufacturer of a multi-capillary electrophoresis device before shipment of the device is referred to “the first spectral calibration”, and spectral calibration by an operator having purchased the multi-capillary electrophoresis device is referred to “the second spectral calibration”.

### Configuration Example of Multi-Capillary Electrophoresis Device

FIG. 5 is a schematic view showing a configuration of a multi-capillary electrophoresis device 500 related to the first embodiment. As shown in FIG. 5, the multi-capillary electrophoresis device 500 includes a device body 501 and a control computer 502.

The device body 501 includes a computation control circuit 503, a photodetector 504, a constant temperature reservoir 505, a capillary array 506, a light source 507, a light irradiation unit 508, a load header 509, a negative pole buffer container 511, a sample container 512, a polymer cartridge 513, a positive pole buffer container 514, a positive pole 515, a high tension power source 516, an array header 517, a transporter 518, a syringe mechanism 520, a heating/cooling mechanism 523, and a diffraction grating 524.

The device body 501 is connected to the control computer 502 in a communicatable manner. An operator can operate each unit included in the device body 501 by operating the control computer 502. The control computer 502 receives data acquired by the device body 501 (such as a detection signal of the photodetector 504). The control computer 502 includes a display that displays the data having been received. Also, the control computer 502 may be incorporated into the device body 501.

The computation control circuit 503 performs calculation processing of a measurement value (fluorescence strength) based on a detection signal of the photodetector 504, and performs correction of the measurement value (fluorescence strength). Also, the computation control circuit 503 controls the device body 501 according to an input and a command from the control computer 502.

The photodetector 504 is a light sensor detecting fluorescence generated by laser light as excitation light irradiated from the light source 507 to the capillary array 506. For the light source 507, liquid laser, gas laser, semiconductor laser, and the like can be used appropriately, and an LED also can be used alternatively. The light source 507 may be configured to irradiate excitation light from both sides of an array of the capillary array 506, and may be configured to irradiate excitation light in time division.

The constant temperature reservoir 505 is a temperature control mechanism for controlling the temperature of the capillary array 506. The constant temperature reservoir 505 is covered by a heat insulation material to keep the temperature within the reservoir constant, and the temperature is controlled by the heating/cooling mechanism 523. Thus, the temperature of a major portion of the capillary array 506 can be maintained to a constant temperature of approximately 60° C. for example.

The capillary array 506 is configured by arraying plural capillaries 519 (electrophoresis paths) (four in an example of FIG. 5). The capillary array 506 can be configured as a replacement member capable of being replaced appropriately by a new one when damage and qualitative deterioration have been confirmed. Also, the capillary array 506 can be replaced by a separate capillary array including a capillary with different number of piece and length according to measurement.

Each of the plural capillaries 519 configuring the capillary array 506 can be configured of a glass pipe with several tens to several hundreds µm of the inside diameter and several hundreds µm of the outside diameter. Also, in order to increase the strength, the surface of the glass pipe may be covered by a polyimide coat. However, at a position where laser light is irradiated and the vicinity thereof, the polyimide coat on the surface of the capillaries 519 is removed. The inside of the capillaries 519 is filled with a separation medium for separating DNA molecules in a biological sample (sample). Here, polyacrylamide-based separation gel (will be hereinafter expressed “polymer”) which is commercially available for electrophoresis use is to be used.

The light irradiation unit 508 is disposed in a part of the capillary array 506. As described below, the light irradiation unit 508 is configured to be capable of causing the laser light (excitation light) from the light source 507 to enter the capillaries 519 of a plural number of piece commonly and introducing fluorescence produced from the capillaries 519 of a plural number of piece to the photodetector 504. To be more specific, in order to irradiate laser light that is measurement light to a light irradiation portion arranged in the capillary array 506, the light irradiation unit 508 includes a projection optical system such as an optical fiber and a lens. The diffraction grating 524 (dispersion element) disperses the light from the capillaries 519, and causes the same to enter the photodetector 504.

Although an example of detecting fluorescence from a fluorescent dye by irradiation of excitation light by the photodetector 504 is explained in the present disclosure, detected light is not limited to fluorescence, and may be absorbed light, produced light, and the like.

The load header 509 is arranged at an end of the capillary array 506. The load header 509 functions as a negative pole to which a negative voltage for introducing the biological sample (sample) into the capillaries 519 is applied. At the other end of the capillary array 506, the array header 517 is arranged, and the array header 517 bundles the plural capillaries 519 into one. Also, the array header 517 includes a sharp point portion 521 for insertion into the polymer cartridge 512 in the lower surface of the array header 517.

The transporter 518 is configured to mount the negative pole buffer container 511, the sample container 512, the polymer cartridge 513, and the positive pole buffer container 514 on the upper the surface of the transporter 518 and to transport them. As an example, the transporter 518 includes three motors and linear actuators, and can move in three axial directions of up and down, left and right, and front and rear.

The negative pole buffer container 511 and the positive pole buffer container 514 are containers holding a buffer for migration, and the sample container 512 is a container holding a sample of the measurement object (sample).

The polymer cartridge 513 is a container holding polymer for migration. The polymer cartridge 513 is sealed by a raw material with high plasticity such as rubber or silicone at an upper portion 522, and is connected to the syringe mechanism 520 for filling the polymer and the transporter 518.

Procedures in filling the polymer into the capillaries 519 from the polymer cartridge 513 are as per (1) to (3) below.
(1) The transporter 518 is operated, and the array header 517 moves to the upper side of the polymer cartridge 513.
(2) The sharp point portion 521 of the array header 517 penetrates the upper portion 522 of the polymer cartridge 513. At this time, since the upper portion 522 of the polymer cartridge 513 having high plasticity encloses the sharp point portion 521 of the array header 517, both are closely attached to each other, and the polymer cartridge 513 and the capillaries 519 are connected to each other in a sealed state.
(3) The syringe mechanism 520 pushes up the polymer of the inside of the polymer cartridge 513, and pours the polymer into the capillaries 519.

In the positive pole buffer container 514, the positive pole 515 applying a positive voltage for migration is disposed so as to contact the buffer. The high tension power source 516 is connected between the positive pole 515 and the load header 509 as a negative pole.

The transporter 518 transports the negative pole buffer container 511 and the sample container 512 to a negative pole end 510 of the capillaries 519. At this time, the positive pole buffer container 514 interlockingly moves to the sharp point portion 521 that corresponds to a positive pole end of the capillaries 519.

The sample container 512 incorporates sample tubes of a number of piece same as that of the capillaries 519. The operator dispenses the DNA to the sample tubes.

The computation control circuit 503 (computation unit) includes a measurement value computation unit 5032, a correction factor computation unit 5033, a correction factor database 5034, and a correction unit 5035.

The measurement value computation unit 5032 calculates a measurement value (fluorescence strength) based on a detection signal of the photodetector 504. The correction factor computation unit 5033 calculates a correction factor for correcting the measurement value calculated by the measurement value computation unit 5032. The correction factor database 5034 stores the correction factor calculated by the correction factor computation unit 5033. Also, the correction unit 5035 calculates a corrected measurement value by applying the correction factor stored in the correction factor database 5034 to the measurement value of the measurement value computation unit 5032. Computation processing of each unit of the computation control circuit 503 described above can be achieved by that a processor such as a CPU and an MPU for example performs a program.

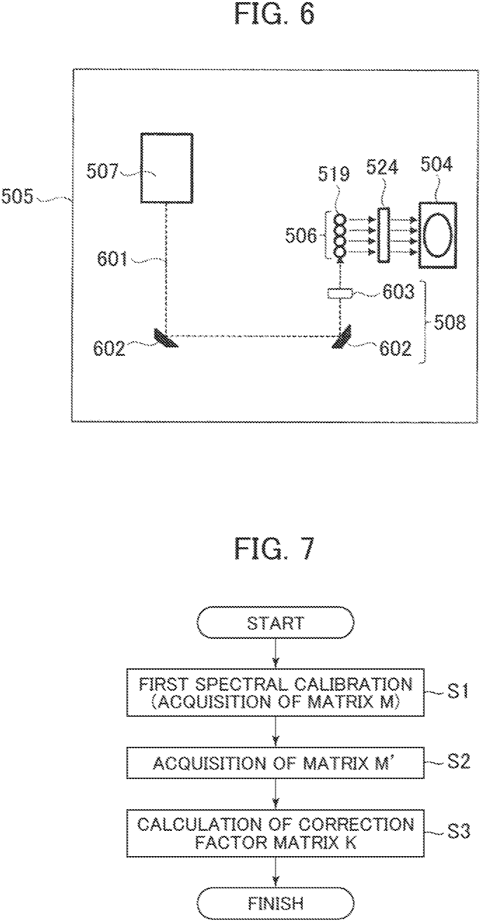

FIG. 6 is a schematic view showing a configuration of an optical system within the constant temperature reservoir 505. As shown in FIG. 6, the light irradiation unit 508 includes plural reflection mirrors 602 (two in FIG. 6) and a condenser lens 603 as an example. The reflection mirror 602 changes the traveling direction of laser light 601 from the light source 507. Also, the condenser lens 603 condenses the laser light to a light irradiation portion of the capillary array 506. Thus, the laser light 601 enters the plural capillaries 519 in sequence. The fluorescent dye within each capillary 519 is excited by the laser light 601, and produces information light (fluorescence having a wavelength depending on the sample). This information light is dispersed to a wavelength direction by the diffraction grating 524. The information light having been dispersed is detected by the photodetector 504. At this time, although the photodetector 504 can measure a spectrum continuously (discretely for each pixel in fact), in the present embodiment, as an example, only the signal strength in the twenty wavelengths λ(0) to λ(19) is to be acquired.

Thus, by observing the fluorescence strength of the fluorescence produced by entering of the laser light 601 by the photodetector 504, an analysis of the DNA during electrophoresis is enabled. Electrophoresis means to separate a sample by a difference of movability depending on the property of a sample, the movability being given to a sample in a capillary 119 by an electric field action generated between the negative pole and positive pole buffers. Here, explanation will be given exemplifying a case where the sample is a DNA.

The DNA has a negative electric charge in the polymer by a phosphodiester bond which corresponds to a skeleton of a double helix. Therefore, the DNA moves to the positive pole side in a DNA electric field. At this time, since the polymer has a net-like structure, movability of the DNA depends on easiness in going through the net, namely the size of the DNA. A DNA having a short base length easily goes through the net-like structure and movability becomes high. Results of a DNA having a long base length are opposite. Since the DNA is labeled by a fluorescence substance (fluorescent body) beforehand, the photodetector 504 optically detects the DNA in sequence starting from a DNA having a short base length. Normally, the measuring time and the voltage application time are set matching a sample with the longest migration time.

### Calculation Method for Correction Factor

As described above, the present embodiment proposes a correction method for the fluorescence spectrum of a case where the migration voltage differs between the time of the spectral calibration and the time of migration of the actual sample. The manufacturer of the multi-capillary electrophoresis device 500 obtains a correction factor for correcting the fluorescence spectrum acquired at the time of migration of an actual sample and registers the correction factor to the correction factor database 5034 of the computation control circuit 503 before shipment of the device.

FIG. 7 is a flowchart showing a calculation method for a correction factor. The calculation method for the correction factor will be summarized. First, in step S1, the manufacturer performs the spectral calibration using a matrix standard, and acquires a matrix M becoming a reference by the computation control circuit 503. Next, in step S2, a matrix M′ used for correction is acquired by the computation control circuit 503. Lastly, in step S3, a correction factor matrix K is acquired by the computation control circuit 503.

### Step S1

In step S1, the manufacturer performs the spectral calibration using a matrix standard including a DNA fragment labeled by an optional fluorescent dye (the first spectral calibration). In the present embodiment, as an example, ROX, TMR, R110, and R6G are used as the fluorescent dye. The migration voltage should be made same as a migration voltage in the spectral calibration before migration of the actual sample described below (the second spectral calibration). In the present embodiment, although the migration voltage is made 15 kV as an example, the migration voltage is not limited to it.

The manufacturer registers the kind of the fluorescent dye and the migration voltage in the computation control circuit 503 by operating an input device of the control computer 502. The measurement value computation unit 5032 is to obtain the matrix M with this condition.

Here, one of the problems to be solved in the present disclosure is that, when the migration voltage differs between the time of the spectral calibration by an operator and the time of migration of the actual sample, a deviation occurs between the reference spectrum and the fluorescence spectrum of the actual sample. The migration voltage affects the time required for electrophoresis and the separation capacity which is one of the important quality indicators in an analysis. Therefore, in using the multi-capillary electrophoresis device, an operator frequently changes the migration voltage of the actual sample according to the necessity. Also, whenever the migration voltage of the actual sample is changed, the operator is required to repeat the spectral calibration with a same migration voltage as that of the actual sample.

In order to solve this problem, the present embodiment proposes to perform the first spectral calibration with various migration voltages before shipment of the multi-capillary electrophoresis device, to quantify the deviation between the spectra found out there, and to thereby register such correction factor to minimize the deviation in the computation control circuit 503 beforehand. The correction factor is registered along with the information such as the fluorescent dye and the migration voltage having been used.

The operator having purchased the device selects an optional migration voltage out of those having been registered in the computation control circuit 503, performs the second spectral calibration, and is enabled thereafter to make an actual sample to migrate with an optional migration voltage having been registered in the computation control circuit 503 in a similar manner. That is to say, even when the migration voltage of an actual sample may be changed by any number of times within a range registered in the computation control circuit 503, the operator is not required to repeat the spectral calibration each time.

When the operation described above is assumed, in step S1, the manufacturer should perform migration of the matrix standard not only with 15 kV but also with plural voltages. Also, all of the matrix M having been acquired should be registered in the computation control circuit 503 along with the information of the migration voltage and the fluorescent dye.

The calculation method for the matrix M is as per one described above.

### Step S2

In step S2, the manufacturer makes the matrix standard to migrate with a fluorescent dye and a migration condition same as those of an actual sample. Here, the actual sample is to be labeled by a fluorescent dye same as that for the matrix standard having been used in step S1 and is to be made to migrate with 7.5 kV. At this time, by operating an input device of the control computer 502, the manufacturer registers the kind of the fluorescent dye and the migration voltage in the computation control circuit 503.

As described above, since the matrix standard includes DNA fragments with different length having been labeled respectively by a different fluorescent dye, each fluorescent dye produces light in isolation at each peak time (t0′, t1′, t2′, and t3′). Also, since the appearance order of the peak time corresponding to each fluorescent dye is known, the kind of the fluorescent dye corresponding to each peak time can be identified.

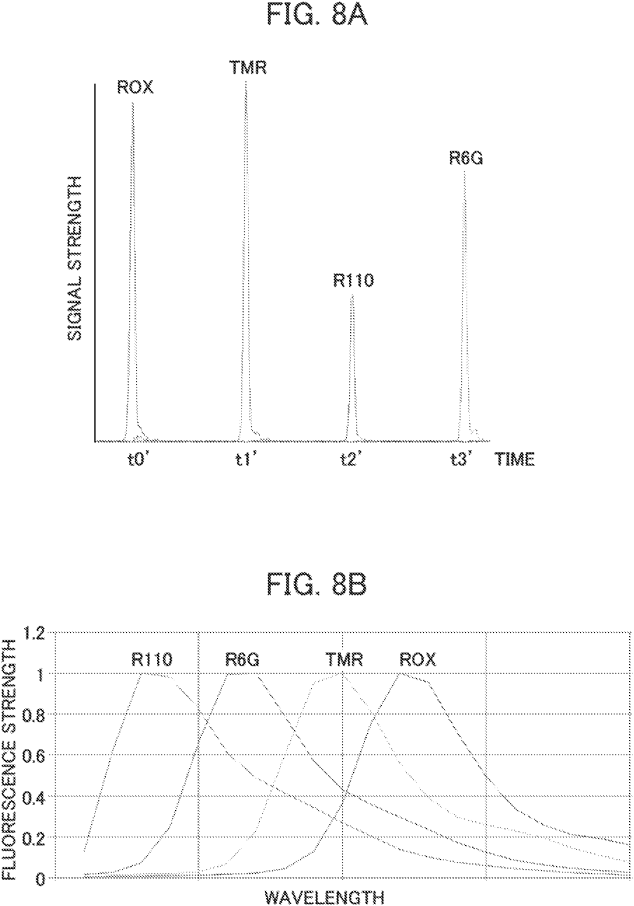

FIG. 8A is a drawing showing a waveform of a signal strength obtained by performing electrophoresis of the matrix standard, the vertical axis shows the signal strength, and the horizontal axis shows the time. As shown in FIG. 8A, ROX produces light at the time t′0, TMR produces light at the time t′1, R110 produces light at the time t′2, and R6G produces light at the time t′3 respectively in isolation. The spectrum of each time corresponds to the fluorescence spectrum of each fluorescent dye. Therefore, the computation control circuit 503 acquires the fluorescence spectrum of each fluorescent dye by acquiring the spectrum of each peak time.

FIG. 8B is the fluorescence spectrum acquired from the signal strength waveform of FIG. 8A, the vertical axis shows the fluorescence strength, and the horizontal axis shows the wavelength.

The measurement value computation unit 5032 calculates the matrix M′ using each fluorescence spectrum. The mathematical expression 2 described below shows an example of the matrix M′ of a case of acquiring the signal strength in the twenty wavelengths λ(0) to λ(19). The element of the matrix M′ corresponds to the strength ratio of each fluorescent dye at each peak time (t′0, t′1, t′2, and t′3) and each wavelength. For example, an element W’X1 of the mathematical expression 2 is a rate of the fluorescence strength of the fluorescent dye ROX at the time t′0 and the wavelength λ(1).

$$\begin{matrix}\text{M′ =} \left[\begin{matrix}W {′}_{X 0} & W {′}_{X 1} & W {′}_{X 2} \\ W {′}_{T 0} & W {′}_{T 1} & W {′}_{T 2} \\ W {′}_{R 0} & W {′}_{R 1} & W {′}_{R 2} \\ W {′}_{G 0} & W {′}_{G 1} & W {′}_{G 2}\end{matrix} \cdot \cdot \cdot \cdot \cdot \cdot \cdot \begin{matrix}W {′}_{X 18} & W {′}_{X 19} \\ W {′}_{T 18} & W {′}_{T 19} \\ W {′}_{R 18} & W {′}_{R 19} \\ W {′}_{G 18} & W {′}_{G 19}\end{matrix}\right] \\ \begin{matrix}X ⇒ & \text{ROX} \\ T ⇒ & \text{TMR} \\ R ⇒ & \text{R110} \\ G ⇒ & \text{R6G}\end{matrix}\end{matrix}$$

Further, in step S2 also, due to such reason as described in step S1, in an actual operation, the matrix standard is made to migrate with plural voltages including 7.5 kV, and all acquired matrices M′ are registered in the computation control circuit 503 along with the information such as the migration voltage and the fluorescent dye.

### Step S3

Returning to FIG. 7, in step S3, the measurement value computation unit 5032 transmits the matrices M and M′ having been calculated to the correction factor computation unit 5033. The correction factor computation unit 5033 acquires the correction factor matrix K based on the matrices M and M′. In the fluorescent dye i and the wavelength j, the element of the correction factor matrix K is defined to be the element k(ij) of the correction factor matrix k(ij)=w′(ij)/w(ij). As described already, the fluorescent dye and the migration voltage used in step S2 have been registered in the computation control circuit 503. Therefore, k(ij) can be accumulated in the correction factor database 5034 along with the information of the migration condition and the fluorescent dye used for calculation. At this time, as described in steps S1 and S2, when the matrices M and M′ have been acquired with plural migration voltages, the correction factor computation unit 5033 calculates the correction factor matrix K in all combinations thereof, and registers the same in the correction factor database 5034 along with the information of the migration voltage and the fluorescent dye.

### Analysis Method by Electrophoresis of Actual Sample

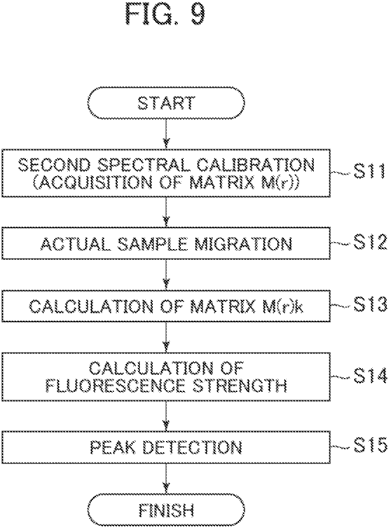

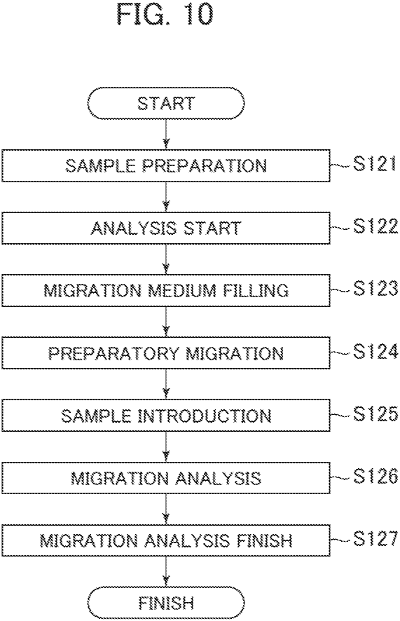

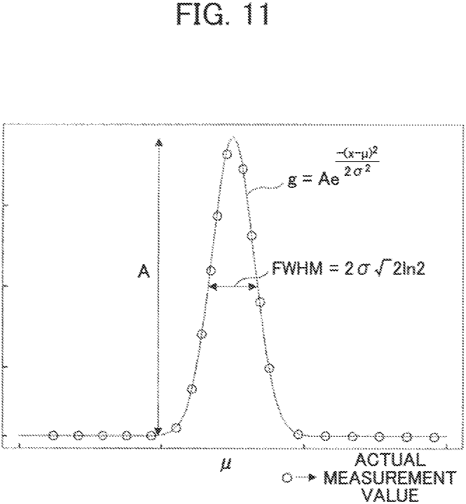

FIG. 9 is a flowchart showing an application method of a correction factor in electrophoresis of an actual sample by an operator.

### Step S11

Steps S1 to S3 described above have already been completed at the time point when the operator purchased the multi-capillary electrophoresis device 500. The operator only has to perform only operations of step S11 and onward. Also, it is assumed that, at the time of the purchase (after step S3), the capillaries were detached and attached for the purpose of transportation of the device, and the positional relation between the photodetector 504 and the capillaries 519 changed. That is to say, the device is in a state of requiring the spectral calibration again.

In step S11, the operator performs the spectral calibration using the matrix standard in a manner similar to step S1. For the sake of convenience, the spectral calibration performed by the operator is referred to “the second spectral calibration”. The migration voltage in the second spectral calibration can be selected optionally as far as it is a migration voltage registered in the correction factor database 5034. In the present embodiment, as an example, migration is to be effected with 15 kV. Also, with respect to the fluorescent dye, it is assumed that the matrix standard has been labeled by ROX, TMR, R110, and R6G. The matrix M acquired by the measurement value computation unit 5032 in the second spectral calibration of step S11 is made a matrix M(r).

### Step S12

In step S12, the operator performs migration of the actual sample. Although the actual sample is an unknown sample, the kind of the fluorescent dye and the migration voltage are assumed to be known. The migration condition of the actual sample is made 7.5 kV used in step S2. With respect to the fluorescent dye, it is assumed that the actual sample also has been labeled by ROX, TMR, R110, and R6G in a manner similar to the matrix standard.

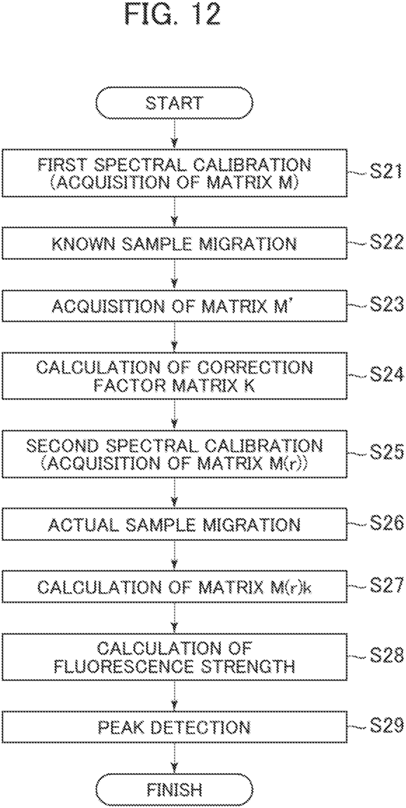

FIG. 10 is a flowchart of an electrophoresis method of the actual sample in step S12. As shown in FIG. 10, the basic procedure of electrophoresis includes sample preparation (step S121), analysis start (step S122), separation medium filling (step S123), preparatory migration (step S124), sample introduction (step S125), and migration analysis (step S126).

### Step S121

In step S121, as sample of preparation before starting an analysis, the operator sets the sample and the reagent to the multi-capillary electrophoresis device 500. To be more specific, first, the operator fills the negative pole buffer container 511 and the positive pole buffer container 514 shown in FIG. 5 with a buffer solution which forms a part of an energizing path. For the buffer solution, a commercially available electrolyte fluid for electrophoresis can be used for example. Also, the operator dispenses the actual sample which is the analysis object into the well of the sample container 512. The actual sample is a PCR product of a DNA for example. Also, the operator pours a separation medium for causing electrophoresis of the sample into the syringe mechanism 520. For the separation medium, the polymer described above is to be used. Also, the operator replaces the capillary array 506 when deterioration of the capillaries 519 is presumed or when the length of the capillaries 519 is to be changed.

### Step S122

In step S122, by operating an input device of the control computer 502, the operator registers the kind of the fluorescent dye and the migration voltage used for the actual sample to the computation control circuit 503. Also, the operator inputs an instruction of analysis start to the control computer 502. When the instruction of the analysis start is inputted, the control computer 502 transits the instruction to the device body 501. Thus, the device body 501 starts in an analysis.

### Step S123

In step S123, the device body 501 starts polymer filling into the capillaries 519. Polymer filling is a procedure of filling new polymer into the capillaries 519 to form a migration path.

In polymer filling in the present embodiment, first, the negative pole buffer container 511 is carried to right below the load header 509 by the transporter 518 shown in FIG. 5 so as to be capable of receiving the spent polymer discharged from the negative pole end 510 of the capillaries 519. Also, the syringe mechanism 520 is driven to fill the capillaries 519 with new polymer, and the spent polymer is disposed of. Lastly, in order to prevent the separation medium from being dried, the negative pole end 510 is immersed in the buffer solution within the negative pole buffer container 511.

### Step S124

In step S124, the device body 501 performs preparatory migration. Preparatory migration is a procedure of applying a predetermined voltage to the polymer to achieve a state of the polymer suitable to electrophoresis.

In preparatory migration in the present embodiment, first, the negative pole end 510 is immersed in the buffer solution within the negative pole buffer container 511 by the transporter 518, and the energizing path is formed. Also, by the high tension power source 516, voltage of approximately several to several tens kV is applied to the polymer for several to several tens minutes to achieve a state of the polymer suitable to electrophoresis. Lastly, in order to prevent the polymer from being dried, the negative pole end 510 is immersed in the buffer solution within the negative pole buffer container 511.

### Step S125

In step S125, the device body 501 introduces a sample component to the migration path. This step may be performed automatically, or may be performed by that a control signal is transmitted from the control computer 502 from time to time.

In sample introduction in the present embodiment, first, the negative pole end 510 is immersed in the sample held within the well of the sample container 512 by the transporter 518. Thus, an energizing path is formed, and a state of enabling to introduce the sample component into the migration path is achieved. Also, a pulse voltage is applied to the energizing path by the high tension power source 518 to introduce the sample component to the migration path. Lastly, in order to prevent the polymer from being dried, the negative pole end 510 is immersed in the buffer solution within the negative pole buffer container 511.

### Step S126

In step S126, the device body 501 performs migration analysis. In migration analysis, each sample component included in the sample is separated and analyzed by electrophoresis.

In migration analysis in the present embodiment, first, the negative pole end 510 is immersed in the buffer solution within the negative pole buffer container 511 by the transporter 518, and the energization path is formed. Next, a high voltage of 7.5 kV is applied to the energization path by the high tension power source 516 to generate an electric field in the migration path. By the electric field having been generated, each sample component within the migration path moves to the light irradiation unit 508 at a speed depending on the property of each sample component. That is to say, the sample component is separated by the difference in the moving speed thereof. Also, the photodetector 504 effects detection in sequence from the sample component having reached the light irradiation unit 508.

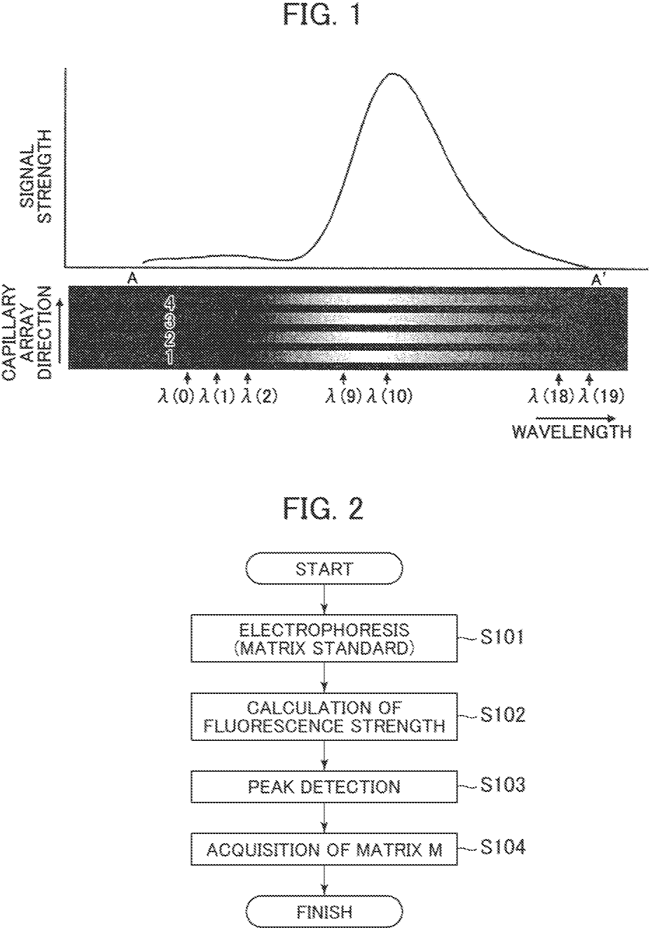

For example, when the sample includes many DNAs with different base length, a difference occurs in the moving speed by the base length thereof, and the DNA reaches the light irradiation unit 508 in sequence from a DNA with short base length. To each DNA, a fluorescent dye corresponding to an analysis object is bonded. When excitation light is irradiated to the light irradiation unit 508 from the light source 507, information light (fluorescence having a wavelength depending on a sample) is produced from the sample and is discharged to the outside. This information light is dispersed in the wavelength direction by the diffraction grating 524, and is detected by the photodetector 504. An example of images detected by the photodetector 504 is FIG. 1. During migration analysis, in the photodetector 504, this information light is detected at a constant temporal interval, and image data are transmitted to the computation control circuit 503. Alternatively, in order to reduce the information amount to be transmitted, the photodetector 504 may transmit not the image data but brightness (signal strength) of only a part of regions in the image data. For example, the strength of only a wavelength position of a constant interval may be transmitted for each capillary.

As stated in the explanation of FIG. 1, in the present embodiment, out of the image data described above, only the signal strength data in the twenty wavelengths λ(0) to λ(19) are to be transmitted to the computation control circuit 503 for each capillary. The signal strength data expresses a spectrum of each DNA sample in each capillary, and this spectrum is stored in the measurement value computation unit 5032. In the measurement value computation unit 5032, the spectra of all of the capillaries 519 at all detection times during migration analysis described above are stored. Further, although the spectra of all detection times can be stored in the measurement value computation unit 5032, when only a predetermine peak time is important for an operator, only the spectra of the vicinity of the predetermine time may be stored.

### Step S127

In step S127, when acquisition of the image data having been planned is completed, the device body 501 stops application of voltage, and migration analysis is finished.

The above is an example of processing of electrophoresis processing (step S12) in FIG. 9. Also, steps S123 to S127 may be performed automatically by the device body 501, and may be performed by transmission of a control signal from the control computer 502 from time to time.

### Step S13

Returning to FIG. 9, in step S13, the correction unit 5035 calls up a correction factor matrix K having combination of same migration voltage and fluorescent dye as that of the time of acquisition of the matrix M(r) and the actual sample of step S12 from the correction factor database 5034, and calculates a matrix M(r)k by multiplication of each element of the matrix M(r) and each element k(ij) of the matrix K.

### Step S14

In step S14, the correction unit 5035 calculates the fluorescence strength. To be more specific, the correction unit 5035 calculates the strength of each fluorescent dye from the image data obtained in electrophoresis processing (step S12) described above. In the present step S14, the strength ratio of each fluorescent dye in the wavelengths λ(0) to λ(19) only has to be multiplied to the spectrum of each capillary 519 at each time and to be added. When this is expressed by a matrix, the result is as per the mathematical expression 3 below.

$$\begin{matrix}\begin{matrix}\text{c} = \text{M} \left(\text{r}\right) \text{k f} \\ \text{c} = \left[{c}_{X} {c}_{T} {c}_{R} {c}_{G}\right] \\ \text{f} = \left[{f}_{0} {f}_{1} {f}_{2} \cdot \cdot \cdot \cdot \cdot \cdot {f}_{18} {f}_{19}\right]\end{matrix} \\ \text{M} \left(\text{r}\right) \text{k} = \left[\begin{matrix}w {\left(r\right)}_{X 0} {k}_{\left(X 0\right)} & w {\left(r\right)}_{X 1} {k}_{\left(X 2\right)} & w {\left(r\right)}_{X 2} {k}_{\left(X 2\right)} \\ w {\left(r\right)}_{T 0} {k}_{\left(T 0\right)} & w {\left(r\right)}_{T 1} {k}_{\left(T 1\right)} & w {\left(r\right)}_{T 2} {k}_{\left(T 2\right)} \\ w {\left(r\right)}_{R 0} {k}_{\left(R 0\right)} & w {\left(r\right)}_{R 1} {k}_{\left(R 1\right)} & w {\left(r\right)}_{R 2} {k}_{\left(R 2\right)} \\ w {\left(r\right)}_{G 0} {k}_{\left(G 0\right)} & w {\left(r\right)}_{G 1} {k}_{\left(G 1\right)} & w {\left(r\right)}_{G 2} {k}_{\left(G 2\right)}\end{matrix} \cdot \cdot \cdot \cdot \cdot \cdot \cdot \begin{matrix}w {\left(r\right)}_{X 18} {k}_{\left(X 18\right)} & w {\left(r\right)}_{X 19} {k}_{\left(X 19\right)} \\ w {\left(r\right)}_{T 18} {k}_{\left(T 18\right)} & w {\left(r\right)}_{T 19} {k}_{\left(T 19\right)} \\ w {\left(r\right)}_{R 18} {k}_{\left(R 18\right)} & w {\left(r\right)}_{R 19} {k}_{\left(R 19\right)} \\ w {\left(r\right)}_{G 18} {k}_{\left(G 18\right)} & w {\left(r\right)}_{G 19} {k}_{\left(G 19\right)}\end{matrix}\right] \\ \begin{matrix}X ⇒ & \text{ROX} \\ T ⇒ & \text{TMR} \\ R ⇒ & \text{R110} \\ G ⇒ & \text{R6G}\end{matrix}\end{matrix}$$

Here, the vector C expresses the fluorescence strength of each fluorescent dye having been used. Therefore, the elements Cx, C_{T}, C_{R}, and C_{G} of the vector C express the fluorescence strength of ROX, TMR, R110, and R6G respectively. The vector f expresses the signal strength observed by the photodetector 504. The elements f₀ to f₁₉ of the vector f express the signal strength in the wavelengths λ(0) to λ(19) respectively. The elements f₀ to f₁₉ may be an arithmetic mean and the like of the signal strength of the vicinity of the wavelengths λ(0) to λ(19) respectively.

Also, in the measurement signal of each of the wavelengths λ(0) to λ(19) detected by the photodetector 504, Raman scattering light from the polymer filled in the capillaries 519 is included as a base line signal in addition to a signal by the fluorescent dye. Therefore, when the vector f is to be calculated, it is required to remove this base line signal beforehand.

As an example of the removal method for the base line signal, the spectrum of the Raman scattering light is obtained before shipment of the device beforehand, and the spectrum is stored in the computation control circuit 503 as the base line signal. Also, the signal by a fluorescent dye is obtained by deducting the base line signal from the measurement signal at each time, and it can be made the vector f. Alternatively, the minimum value in the vicinity of each time can be made the base line signal value at the time.

In converting the measurement vector f into a fluorescence strength vector, the matrix M(r)k is used.

The correction unit 5035 calculates the fluorescence strength of each fluorescent dye from the measurement spectrum by the mathematical expression 3 described above. By performing this processing to the spectrum of each capillary 519 of each time, the time series data of the fluorescence strength of each capillary 519 can be obtained. These time series data of the fluorescence strength are hereinafter referred to a fluorescence strength waveform.

### Step S15

In step S15, the correction unit 5035 performs peak detection with respect to the fluorescence strength waveform described above. In peak detection, the center position of the peak (peak time), the height of the peak, and the width of the peak are mainly important. The center position of the peak corresponds to the DNA fragment length. The height of the peak is used for quality evaluation of the magnitude of the DNA density in the sample, and so on. The width of the peak is also important in evaluating the quality of the sample and the electrophoresis result. As one of the methods for estimating a peak parameter of such actual data, Gaussian fitting which is a known technology can be used.

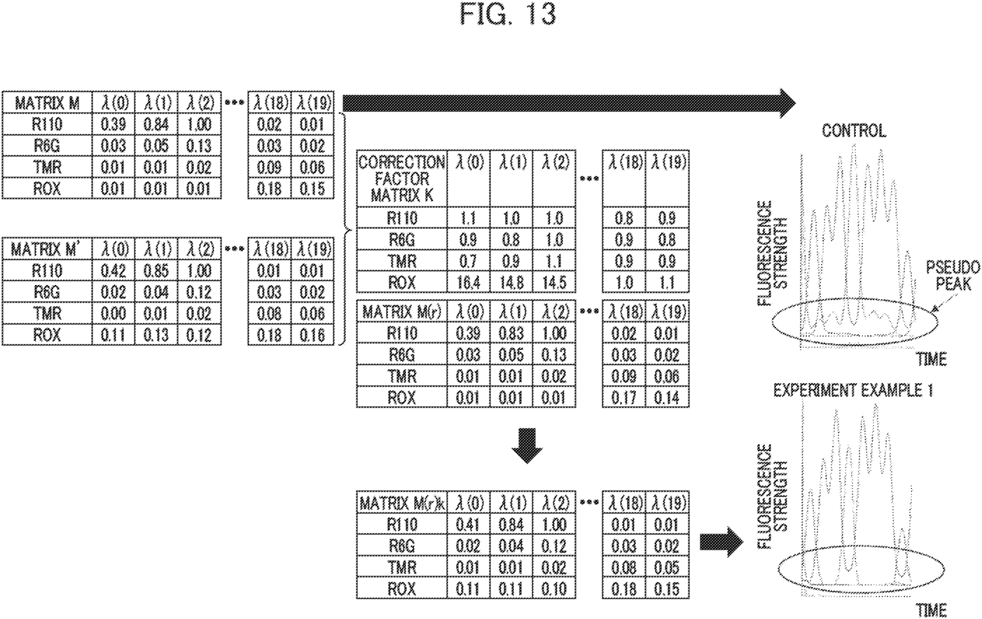

FIG. 11 is a drawing showing a concept of the Gaussian fitting. As shown in FIG. 11, the Gaussian fitting is processing for calculating such parameter (average value µ, standard deviation σ, and maximum amplitude value A) that the Gauss function g approximates the actual data most with respect to the actual data in a constant interval. As an indicator expressing the degree of approximation of the actual data, the least square error of the actual data and the Gauss function value is used frequently. As a numerical value calculation method for minimizing this least square error, the parameter can be optimized using a method such as a Gauss-Newton method. Alternatively, such method that accuracy of a case where two or more peak waveforms are mixed, a case where the data in the vicinity of the peak are dissymmetric, and so on is improved may be applicable. Also, when the variance σ of the Gauss function g is determined, the full width at half maximum (FWHM) of it is obtained by an expression shown in FIG. 11. This value can be made the peak width.

Thus, the correction unit 5035 obtains the peak parameter with respect to the fluorescence strength waveform of all fluorescent dyes. At this time, when the width of the peak and the height of the peak do not fulfill a predetermined threshold condition, they may be removed from the peak.

By the operation described above, the signal strength of the actual sample obtained by migration of 7.5 kV is calculated accurately using the matrix M obtained by the migration voltage of 15 kV. Although a combination of predetermined migration voltage is exemplified in the present embodiment, in practice, the operator can optionally select the migration voltage of the second spectral calibration (step S11) and the actual sample migration (step S12) within a range having been registered in the correction factor database 5034.

### Technical Effects

As described above, in the first embodiment, before shipment of the multi-capillary electrophoresis device 500, migration is performed in a same condition as the first spectral calibration and the actual sample with plural migration voltages, and the correction factor matrix K for correcting the deviation of the spectrum is acquired for every combination of the migration voltage and is registered in the correction factor database 5034 along with the information of the fluorescent dye. An operator having purchased the device can perform the second spectral calibration and migration of the actual sample with a combination of the optional migration voltage registered in the correction factor database 5034. Also, even when the operator may change the voltage of the time of migration of the actual sample, the reference spectrum and the fluorescence spectrum of the actual sample do not deviate from each other, therefore even when the second spectral calibration is not repeated, a correct fluorescence strength can be acquired.

### Second Embodiment

Although the matrix M′ is acquired using the matrix standard in the first embodiment, the second embodiment proposes a method for acquiring the matrix M′ using a known DNA sample. The known DNA sample is a PCR product of a DNA, a commercially available standard sample, and so on. In the present embodiment, all of the matrix standard, the known DNA sample, and the actual sample as an example are to be labeled by ROX, TMR, R110, and R6G. Also, the times (t0′, t1′, t2′ and t3′) at which each fluorescent dye produces light in isolation during migration of the known DNA sample are to be known.

FIG. 12 is a flowchart showing an analysis method of a sample related to the second embodiment.

In step S21, in a manner similar to step S1, the manufacturer performs spectral calibration using the matrix standard, and the measurement value computation unit 5032 acquires the matrix M. The migration voltage is made 15 kV.

In step S22, the manufacturer causes the known DNA sample to migrate.

In step S23, the measurement value computation unit 5032 acquires a spectrum at the time (t0′, t1′, t2′ and t3′) at which each fluorescent dye produces light in isolation, and creates the matrix M′ from the strength ratio of each fluorescent dye. The migration voltage is made 7.5 kV.

In step S24, in a manner similar to step S3, the correction factor computation unit 5033 calculates the correction factor matrix K based on the matrices M and M′. The correction factor matrix K is registered in the correction factor database 5034 along with the information of the migration voltage and the fluorescent dye. As described in step S1 of the first embodiment, in an actual operation, steps S21 and S21 are performed with various migration voltages, and the plural matrices M and M′ are acquired. When migration is effected with plural voltages, all correction factor matrices K are registered.

In a manner similar to the first embodiment, steps S21 to S24 have been performed by the manufacturer side before shipment of the multi-capillary electrophoresis device 500, and the correction factor matrix K has already been registered in the correction factor database 5034. The work actually performed by the operator having purchased the device becomes the next step S25 and onward. Here, it is assumed that, after step S24, the capillaries 519 have been detached and attached at the time of transportation, and the positional relation between the photodetector 504 and the capillaries 519 has changed. When detachment and attachment of the capillaries 519 have not been performed in step S24 and onward, out of the matrices M obtained in step S21, one with a migration voltage same as that of migration of the actual sample (step S21) can be selected to be made the matrix M(r)k described below.

In step S25, the operator performs the second spectral calibration in a manner similar to step S11, and the measurement value computation unit 5032 acquires the matrix M(r). Although the migration voltage in step S25 is made 15 kV as an example, in an actual operation, an optional one can be selected out of the migration voltages having been registered in the correction factor database 5034.

In step S26, in a manner similar to step S12, the operator performs migration of the actual sample. Although the migration voltage here is made 7.5 kV as an example, in actual practice, the migration voltage can be selected optionally from those having been registered in the correction factor database 5034.

Since steps S27 to S29 are similar to steps S13 to S15 (FIG. 9) explained in the first embodiment, explanation thereof will be omitted.

By the operation described above, even when the migration voltage differs between the time of the first spectral calibration (step S21) and the time of migration of the actual sample (step S25), the reference spectrum and the fluorescence spectrum of the actual sample do not deviate from each other, and the fluorescence strength of the actual sample is calculated accurately. Although a combination of predetermined migration voltage is exemplified here, in practice, the operator can optionally select the migration voltage of the second spectral calibration (step S25) and the actual sample migration (step S26) within a range having been registered in the correction factor database 5034.

### Technical Effect

As described above, in the second embodiment, in a manner similar to the first embodiment, the operator having purchased the device can perform the second spectral calibration and migration of the actual sample with a combination of optional migration voltages having been registered in the correction factor database 5034. Also, even when the operator may change the voltage of the time of migration of the actual sample, the reference spectrum and the fluorescence spectrum of the actual sample do not deviate from each other, therefore even when the second spectral calibration is not repeated, a correct fluorescence strength can be acquired.

### Experiment Example 1

The effect of the second embodiment was confirmed by a procedure described below.

### Sample

As the matrix standard for the time of the first spectral calibration (step S21), BigDye (Registered Trade Mark) Terminator v3.1 Matrix Standards (Dye Set Z) (made by Applied Biosystems) was used. For both of the known DNA sample (step S22) and the actual sample (step S26), 3500/3500×L Sequencing Standards, BigDye (Registered Trade Mark) Terminator v3.1 (made by Applied Biosystems) was used. With respect to all of the samples described above, ROX, TMR, R110, and R6G are used as the fluorescent dye.

### Analysis Procedure

In the experiment example 1, as a verification of the second embodiment, steps S21 to S26 were performed in a manner described in steps S1, S12, S2, S3, S11, and S12 respectively. The capillary length at the time of migration was 36 cm, the applied voltage at the time of pouring the sample was 1.6 kV, the applied voltage at the time of migration was 15 kV at the time of the first spectral calibration (step S21), and the voltage at the time of migration of the known sample and migration of the actual sample was 7.5 kV.

Next, steps S27 to S29 were performed in a manner described in steps S13 to S15.

As a control of the second embodiment, light intensity calculation and peak detection of the actual sample were performed not applying the correction factor matrix K but using the matrix M. Between the second embodiment and its control, the signal strength of the pseudo peak was compared.

### Experiment Result

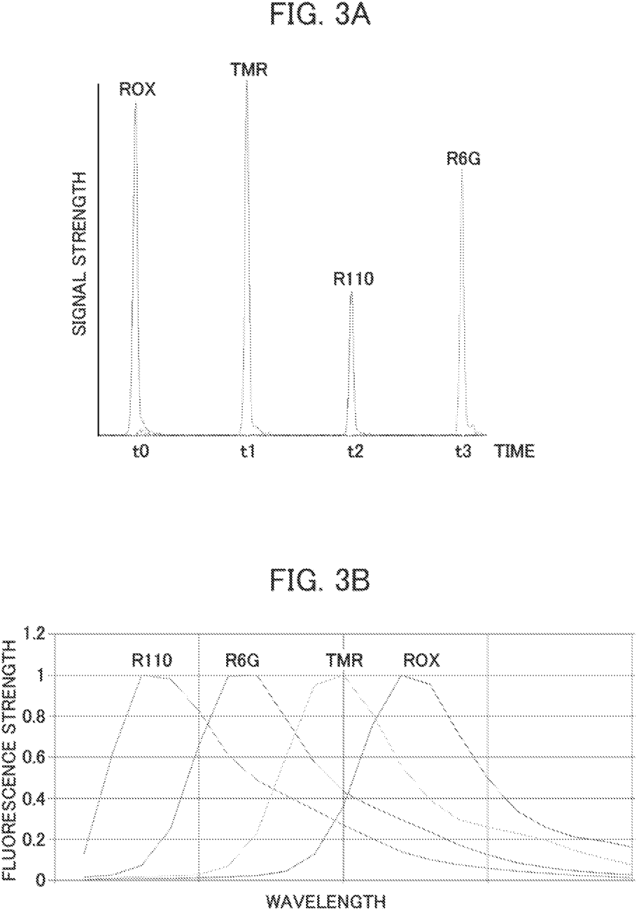

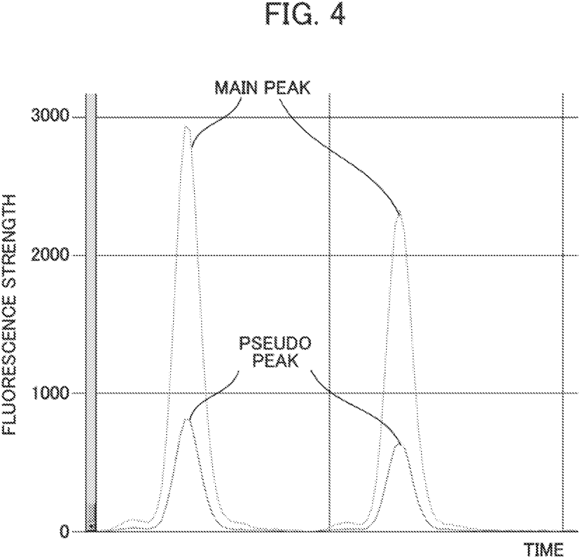

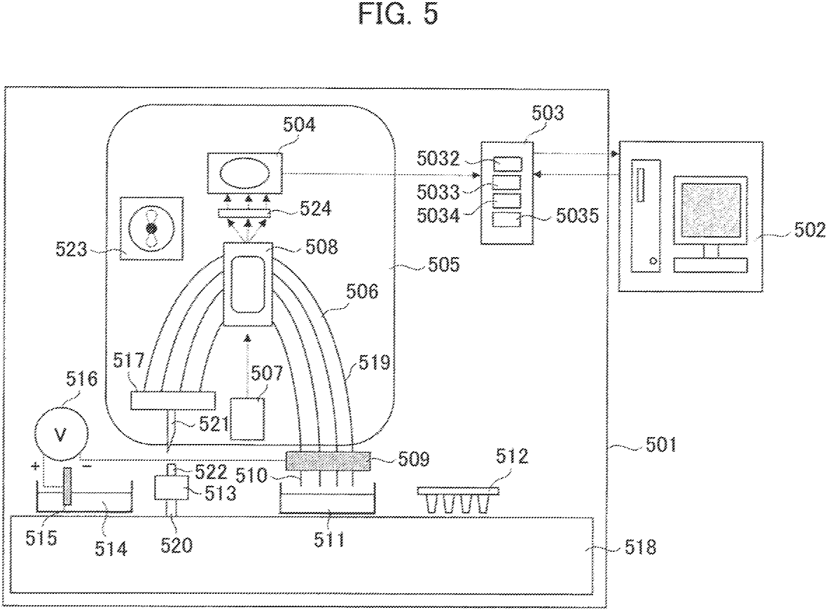

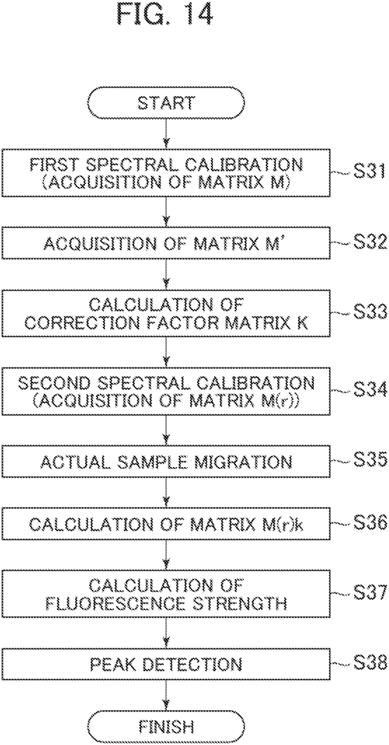

FIG. 13 is a drawing showing the result of the experiment example 1. In FIG. 3, the matrix M, the matrix M′, and the correction factor matrix K obtained by steps S21, S23, and S24 are shown.

With respect to the graph in FIG. 13, the horizontal axis shows the peak time, and the vertical axis shows the fluorescence strength. Although the pseudo peak is confirmed in the control, it is obvious that the pseudo peak is reduced in the method of the second embodiment.

### Third Embodiment

Although explanation was made on a case where the migration voltage was different between the time of the second spectral calibration and the time of migration of the actual sample was explained in the first and second embodiments, a case where the fluorescent dye is different will be explained in the third embodiment. In the present embodiment, as an example, the matrix standard used in the first spectral calibration is to be labeled by FAM, JOE, TMR, and CXR. Also, the actual sample is to be labeled by R6G, R110, TMR, and ROX.

FIG. 14 is a flowchart showing an analysis method of a sample related to the third embodiment.

In step S31, in a manner similar to step S1, the manufacturer performs the spectral calibration using the matrix standard, and the measurement value computation unit 5032 acquires the matrix M. However, for the sample, a matrix standard labeled by FAM, JOE, TMR, and CXR is used.

In step S32, in a manner similar to step S1, the manufacturer acquires the matrix M′ . However, for the sample, a matrix standard labeled by R6G, R110, TMR, and ROX is used.

In step S33, in a manner similar to step S3, the correction factor computation unit 5033 calculates the correction factor matrix K based on the matrices M and M′. The correction factor matrix K is registered in the correction factor database 5034 along with the information of the migration voltage and the fluorescent dye. As described in step S1 of the first embodiment, in an actual operation, steps S31 and S32 are performed with a combination of various fluorescent dyes, and the plural matrices M and M′ are acquired. When migration is effected with a combination of plural fluorescent dyes, all correction factor matrices K are registered.

In a manner similar to the first embodiment, steps S31 to S33 have been performed by the manufacturer side before shipment of the multi-capillary electrophoresis device 500, and the correction factor matrix K has already been registered in the correction factor database 5034. The work actually performed by the operator having purchased the device becomes the next step S34 and onward. Here, it is assumed that, after step S33, the capillaries 519 have been detached and attached at the time of transportation, and the positional relation between the photodetector 504 and the capillaries 519 has changed. When detachment and attachment of the capillaries 519 have not been performed in step S33 and onward, out of the matrices M obtained in step S31, one with a fluorescent dye same as that of migration of the actual sample (step S35) can be selected to be made the matrix M(r)k described below.

In step S34, the operator performs the second spectral calibration in a manner similar to step S11, and the measurement value computation unit 5032 acquires the matrix M(r). Although the fluorescent dye in step S34 uses FAM, JOE, TMR, and CXR in the present embodiment, in an actual operation, an optional one can be selected out of the fluorescent dyes having been registered in the correction factor database 5034.

In step S35, in a manner similar to step S12, the operator performs migration of the actual sample. As an example, the actual sample is to be labeled by R6G, R110, TMR, and ROX. However, in an actual operation, an optional one can be selected out of the fluorescent dyes having been registered in the correction factor database 5034.

Since steps S36 to S38 are similar to steps S13 to S15 (FIG. 9) explained in the first embodiment, explanation thereof will be omitted.

By the operation described above, even when the fluorescent dye may differ between the time of the spectral calibration (step S31) and the time of migration of the actual sample (step S35), the reference spectrum and the fluorescence spectrum of the actual sample do not deviate from each other, and the fluorescence strength of the actual sample is calculated accurately. Although a combination of predetermined fluorescent dye is exemplified here, in practice, the operator can optionally change the fluorescent dye of the second spectral calibration (step S34) and the actual sample migration (step S35) within a range having been registered in the correction factor database 5034.

### Technical Effect

As described above, in the third embodiment, before shipment of the multi-capillary electrophoresis device 500, migration with a condition same as that of the first spectral calibration and the actual sample is performed using a sample labeled by a set of different fluorescent dyes, and the correction factor matrix K for correcting the deviation of the spectrum is acquired for each combination of the fluorescent dye and is registered in the correction factor database 5034. The operator having purchased the device can perform the second spectral calibration and migration of the actual sample with a combination of optional fluorescent dyes having been registered in the correction factor database 5034. Also, even when the operator may change the fluorescent dye of the time of migration of the actual sample, the reference spectrum and the fluorescence spectrum of the actual sample do not deviate from each other, therefore even when the second spectral calibration is not repeated, an accurate fluorescence strength can be acquired.

### Experiment Example 2

The effect of the third embodiment was confirmed by a procedure described below.

### Sample

As the matrix standard for the time of the first spectral calibration (step S31), PowerPlex (Registered Trade Mark) 4C Matrix Standards (made by Promega Corporation) was used. For acquisition of the matrix M′ (step S32), BigDye (Registered Trade Mark) Terminator v3.1 Matrix Standards (Dye Set Z) (made by Applied Biosystems) was used. For the actual sample (step S35), 3500/3500×L Sequencing Standards, BigDye (Registered Trade Mark) Terminator v3.1 (made by Applied Biosystems) was used.

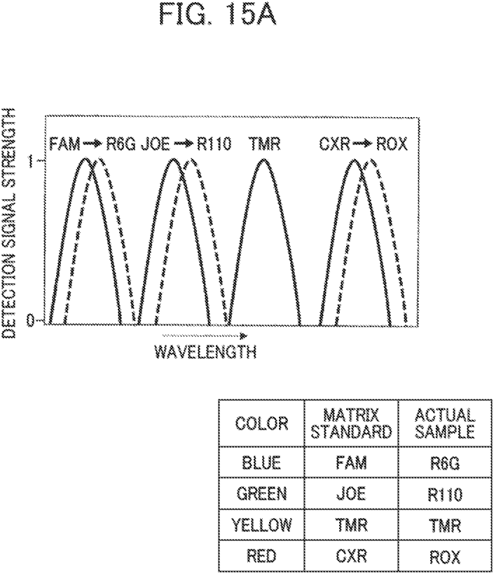

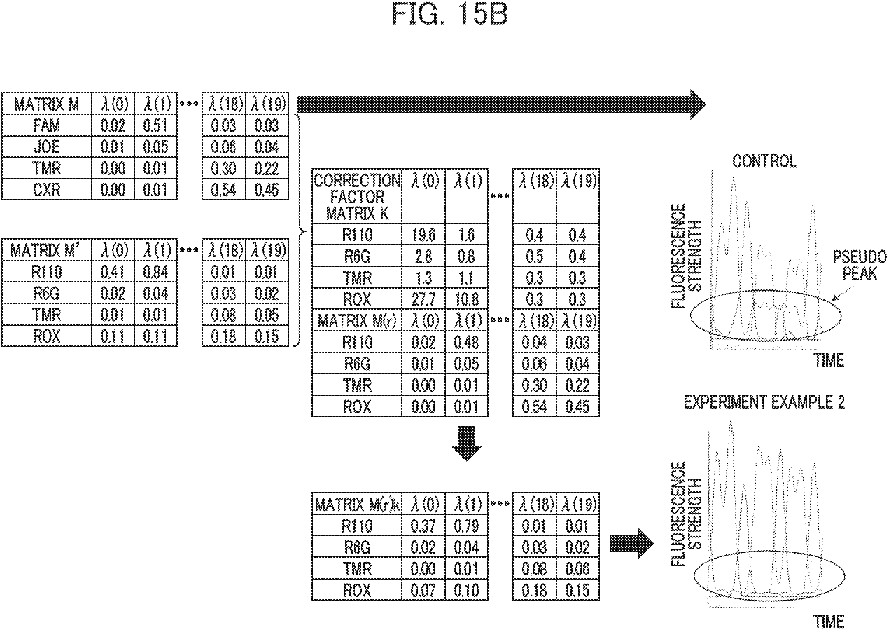

FIG. 15A is a drawing showing a fluorescent dye used in the experiment example 2. As shown in FIG. 15A, for the matrix standard (step S31), FAM, JOE, TMR, and CXR are used as a fluorescent dye. Also, ROX, TMR, R110, and R6G are used for both of steps S32 and S35 as a fluorescent dye.

### Analysis Procedure

In the experiment example 2, as a verification of the third embodiment, steps S31, S32, S33, and S34 were performed in a manner described in steps S1, S1, S3, and S11 respectively. The capillary length at the time of migration was 36 cm, the applied voltage at the time of pouring the sample was 1.6 kV, the applied voltage at the time of migration was 15 kV at all steps at the time of the first spectral calibration (step S31).

Next, steps S35 to S38 were performed in a manner described in steps S12 to S15.

As a control of the third embodiment, light intensity calculation and peak detection of the actual sample were performed not applying the correction factor matrix K but using the matrix M. Between the third embodiment and its control, the signal strength of the pseudo peak was compared.

### Experiment Result

FIG. 15B is a drawing showing the result of the experiment example 2. In FIG. 15B, the matrix M, the matrix M′, and the correction factor matrix K obtained in steps S31 to S33 are shown.

With respect to the graph in FIG. 15B, the horizontal axis shows the peak time, and the vertical axis shows the fluorescence strength. Although the pseudo peak is confirmed in the control, it is obvious that the pseudo peak is reduced in the method of the third embodiment.

### Fourth Embodiment

In the first embodiment, the correction factor matrix K obtained in a predetermined device was applied to data of the actual sample obtained in the same device. The fourth embodiment proposes a method for applying the correction factor matrix K obtained in a predetermined device to data of the actual sample obtained in a separate device.

In the present embodiment, as an example, explanation will be made exemplifying a case where the fluorescent dye is different in a similar manner to the third embodiment (FIG. 14). As an example, the matrix standard used in the first spectral calibration (step S31) is to be labeled by FAM, JOE, TMR, and CXR. Also, the actual sample is to be labeled by R6G, R110, TMR, and ROX.

The first spectral calibration (step S31), acquisition of the matrix M′ (step S32), and calculation of the correction factor matrix K (step S33) are performed in a similar manner to the third embodiment by the manufacturer side with a predetermined multi-capillary electrophoresis device A. The device A transmits the correction factor matrix K to a different device (plural devices) through a network for example, and causes the correction factor matrix K to be registered in the correction factor database 5034 of each device. For example, the correction factor matrix K may be registered in all multi-capillary electrophoresis devices which are before shipment.

Step 34 and onward can be performed in an optional device where the correction factor matrix K same as that in the device A has been registered.

### Technical Effect

As described above, in the fourth embodiment, the correction factor matrix K acquired using a predetermined multi-capillary electrophoresis device is also registered in other devices. Thus, since it is not required to measure the correction factor matrix K in each device, the cost and labor on the manufacturer side are reduced.

### Fifth Embodiment

In the first embodiment, by multiplication of the correction factor matrix K to the matrix M(r) obtained in the second spectral calibration, deviation between the matrix M(r) and the fluorescence spectrum of the actual sample was prevented. The fifth embodiment proposes a method for preventing deviation by changing the wavelength width (signal acquisition width) of a signal detected by the photodetector. With respect to processing similar to that of the first embodiment, explanation will be omitted.

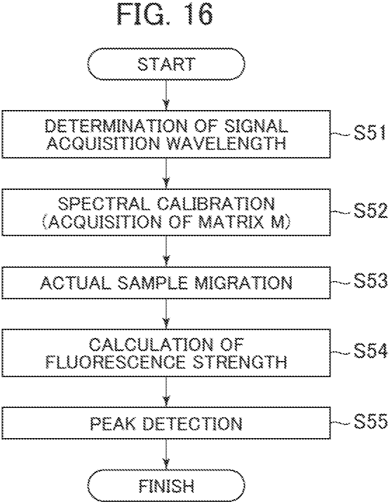

FIG. 16 is a flowchart showing an analysis method of a sample related to the fifth embodiment.

In the present embodiment, the photodetector 504 of the multi-capillary electrophoresis device 500 is to measure the signal strength in the twenty wavelengths λ(0) to λ(19) in sampling the data. Although the twenty wavelengths were cited here as only an example, in practice, an arithmetic mean of the signal strength in the vicinity of each of the wavelengths λ(0) to λ(19) may be taken. Also, the matrix standard is to be labeled by CXR, and the actual sample is to be labeled by ROX. The fluorescence spectra of these fluorescent dyes are known and do not agree to each other.

Since the photodetector 504 of the present embodiment detects the twenty wavelengths only, the fluorescence spectrum of CXR is expressed by a vector Vm formed of twenty pieces of elements, and the fluorescence spectrum of ROX is expressed by a vector Vs formed of twenty pieces of elements.

In step S51, the measurement value computation unit 5032 defines the twenty wavelengths (signal acquisition width) so that the correlation coefficient of the vector Vm and the vector Vs is maximized. At this time, a weight may be given to the local maximum or its vicinity of the spectrum. Further, if it is not an imposition in an actual practice, the correlation coefficient only has to be made sufficiently high, and is not necessarily required to be made a maximum value. That is to say, the signal acquisition width is defined so that the correlation coefficient becomes a predetermined value or more.

In step S52, in a similar manner to step S1, the operator performs the spectral calibration. At this time, the measurement value computation unit 5032 calculates a vector Vc formed of twenty pieces of elements.

In step S53, in a similar manner to step S12, the operator performs migration of the actual sample. Here, the spectrum f acquired by the measurement value computation unit 5032 expresses the signal strength observed by the photodetector 504. Elements f0 to f19 thereof respectively express the signal strength in the wavelengths λ(0) to λ(19).

In step S54, the correction unit 5035 calculates the fluorescence strength. To be more specific, with respect to the spectrum of each of the capillaries 519 at each time, the strength ratio of each fluorescent dye in each of the wavelengths λ(0) to λ(19) only has to be multiplied and to be added up. Expression of it by a matrix is as per the mathematical expression 4 below.

$$\begin{matrix}\text{c=Vmf} \\ \text{f=} \left[{\text{f}}_{0} {\text{f}}_{1} {\text{f}}_{2} ⋅ ⋅ ⋅ ⋅ ⋅ ⋅ {\text{f}}_{18} {\text{f}}_{19}\right] \\ \text{Vm=} \left[{\text{w}}_{0} {\text{w}}_{1} {\text{w}}_{2} ⋅ ⋅ ⋅ ⋅ ⋅ ⋅ {\text{w}}_{18} {\text{w}}_{19}\right]\end{matrix}$$

The vector c is a fluorescence strength spectrum. The vector f expresses the signal strength detected by the photodetector 504. The elements f₀ to f₁₉ of it respectively express the signal strength in the wavelengths λ(0) to λ(19).

Also, as described in step S14 of the first embodiment, in the measurement signal of each of the wavelengths λ(0) to λ(19) detected by the photodetector 504, a Raman scattering light from the polymer filled within the capillary is included as a base line signal in addition to a signal by the fluorescent dye. Therefore, in calculating the vector f, it is required to remove this base line signal beforehand. Base line removal may be performed by a method described in step S14.

In step S55, the correction unit 5035 performs peak detection in a similar manner to step S15.

By the operation described above, even when the fluorescent dye may differ between the time of the spectral calibration (step S1) and the time of migration of the actual sample (step S12), the reference spectrum and the fluorescence spectrum of the actual sample do not deviate from each other, and the fluorescence strength of the actual sample is calculated accurately.

### Technical Effect

As described above, in the fifth embodiment, the photodetector 504 detects light from the capillaries 519 with such wavelength that the correlation coefficient of the fluorescence spectra of the plural fluorescent dyes becomes large. Thus, since the matrix M(r)k is not required at the time of migration, the time required for the analysis can be shortened, and a burden on the computation control circuit 503 can be reduced.

### Experiment Example 3

The effect of the fifth embodiment was confirmed by a procedure described below.

### Device

The multi-capillary electrophoresis device 500 (FIG. 5) explained in the first embodiment can be used. However, as an example in the present embodiment, the photodetector 504 is to detect the signal strength in the twenty wavelengths between 520 nm and 690 nm. In the present experiment example 3, the signal acquisition width for causing a mutual correlation coefficient of two spectra to become sufficiently high is to have been known. The twenty wavelengths expressed by a vector is made λₜₑₛₜ. Also, as a control, a case of acquiring signals at equal intervals of 8.9 nm in a same section is assumed, and the wavelengths of the portion of these twenty pieces are expressed by a vector as λ_{ctrl}. The mathematical expression 5 below shows elements of λₜₑₛₜ and λ_{ctrl}.

$$\begin{matrix}\text{λ} \text{test =} \\ \left(520 \text{529 538 547 556 565 574 583 602 627 634 640 646 653 659 665}\right) \\ \left(671 \text{678 684 690}\right) \\ \text{λ} \text{ctrl =} \\ \left(520 \text{529 538 547 556 565 574 583 592 601 605 518 627 636 645 654}\right) \\ \left(663 \text{672 680 690}\right)\end{matrix}$$

### Sample

As the matrix standard for the time of the spectral calibration (step S52), out of the four peaks included in PowerPlex (Registered Trade Mark) 4C Matrix Standards (made by Promega Corporation), one labeled by CXR was used. For migration of the actual sample (step S53), out of the four peaks included in BigDye (Registered Trade Mark) Terminator v3.1 Matrix Standards (Dye Set Z) (made by Applied Biosystems), one labeled by ROX was used.

### Analysis Procedure

In the experiment example 3, as a verification of the fifth embodiment, steps S52 and S53 were performed in a manner described in steps S11 and S12 respectively. The capillary length at the time of migration was 36 cm, the applied voltage at the time of pouring the sample was 1.6 kV, the applied voltage at the time of migration was 15 kV for both of the time of the spectral calibration (step S52) and the time of migration of the actual sample (step S53).

### Experiment Result

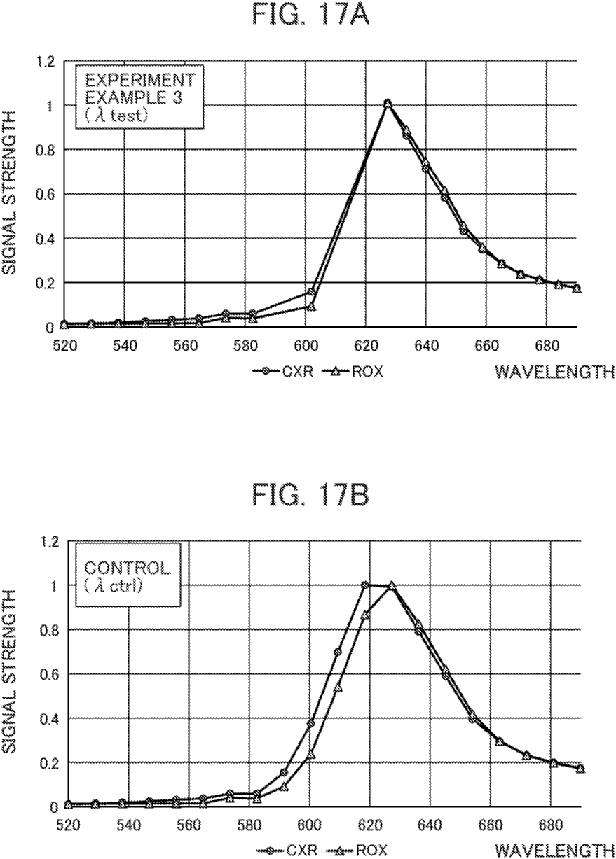

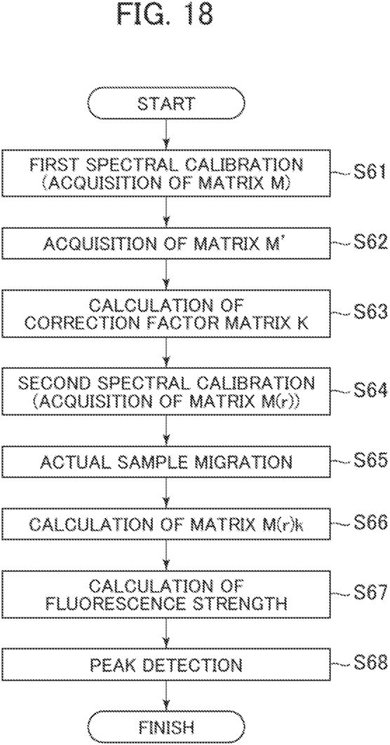

FIG. 17A is a fluorescence spectrum acquired in the experiment example 3. In FIG. 17A, a fluorescence spectrum obtained with λₜₑₛₜ is shown. The mathematical expression 6 below shows the signal strength of the vector Vm and the vector Vs in λₜₑₛₜ. As shown in the mathematical expression 6, the correlation coefficient (corr.) of the vector Vm and the vector Vs of a case of applying λₜₑₛₜ (the fifth) embodiment became 0.998.

$$\begin{matrix}\text{Vm =} \\ \left(\text{0} \text{.01 0} \text{.02 0} \text{.02 0} \text{.03 0} \text{.03 0} \text{.04 0} \text{.06 0} \text{.06 0} \text{.16 1} \text{.00 0} \text{.86 0} \text{.71 0} \text{.58 0} \text{.43 0} \text{.35 0} \text{.29}\right) \\ \left(\text{0} \text{.24 0} \text{.21 0} \text{.19 0} \text{.17}\right) \\ \text{Vs =} \\ \left(\text{0} \text{.01 0} \text{.01 0} \text{.02 0} \text{.02 0} \text{.02 0} \text{.02 0} \text{.04 0} \text{.04 0} \text{.09 1} \text{.00 0} \text{.89 0} \text{.75 0} \text{.62 0} \text{.46 0} \text{.36 0} \text{.29}\right) \\ \left(\text{0} \text{.24 0} \text{.21 0} \text{.19 0} \text{.17}\right) \\ c o r r . = 0.998\end{matrix}$$

FIG. 17B is a fluorescence spectrum acquired in the control experiment of the experiment example 3. In FIG. 17B, a fluorescence spectrum obtained with λ_{ctrl} is shown. The mathematical expression 7 below shows the signal strength of the vector Vm and the vector Vs in λ_{ctrl}. As shown in the mathematical expression 7, the correlation coefficient (corr.) of the vector Vm and the vector Vs of a case of λ_{ctrl} became 0.986.

$$\begin{matrix}\text{Vm =} \\ \left(\text{0} \text{.01 0} \text{.02 0} \text{.02 0} \text{.03 0} \text{.03 0} \text{.04 0} \text{.06 0} \text{.06 0} \text{.16 0} \text{.38 0} \text{.70 1} \text{.00 0} \text{.99 0} \text{.79 0} \text{.59 0} \text{.39}\right) \\ \left(\text{0} \text{.30 0} \text{.23 0} \text{.20 0} \text{.17}\right) \\ \text{Vs =} \\ \left(\text{0} \text{.01 0} \text{.01 0} \text{.02 0} \text{.02 0} \text{.02 0} \text{.02 0} \text{.04 0} \text{.04 0} \text{.09 0} \text{.24 0} \text{.54 0} \text{.87 1} \text{.00 0} \text{.83 0} \text{.62 0} \text{.42}\right) \\ \left(\text{0} \text{.30 0} \text{.23 0} \text{.20 0} \text{.17}\right) \\ c o r r . = 0.986\end{matrix}$$

As is clear from the mathematical expressions 6 and 7, it is known that the mutual correlation coefficient became higher than that of the control (λ_{ctrl}) in applying λₜₑₛₜ namely the fifth embodiment.

### Sixth Embodiment

In the first to the third embodiments, explanation was made on a case where the migration voltage or the fluorescent dye differed between the time of the second spectral calibration and the time of migration of the actual sample. In the sixth embodiment, a case where both of the migration voltage and the fluorescent dye differ will be explained. In the present embodiment, as an example, the matrix standard used in the first spectral calibration is to be labeled by FAM, JOE, TMR, and CXR. Also, the actual sample is to be labeled by R6G, R110, TMR, and ROX. The migration voltage of the time of the spectral calibration is made 15 kV, and the migration voltage of the time of migration of the actual sample is made 7.5 kV.

FIG. 18 is a flowchart showing an analysis method of a sample related to the sixth embodiment.

In step S61, in a similar manner to step S1, the manufacturer performs the spectral calibration using the matrix standard, and the measurement value computation unit 5032 acquires the matrix M. The migration voltage is made 15 kV.

In step S62, in a similar manner to step S2, the manufacturer acquires the matrix M′. However, for the sample, a matrix standard labeled by R6G, R110, TMR, and ROX is used. The migration voltage at this time is 7.5 kV.

In step S63, in a manner similar to step S3, the correction factor computation unit 5033 calculates the correction factor matrix K based on the matrices M and M′. The correction factor matrix K is registered in the correction factor database 5034 along with the information of the migration voltage and the fluorescent dye. As described in step S1 of the first embodiment, in an actual operation, steps S61 and S62 are performed with various combinations of the migration voltage and the fluorescent dye, and the plural matrices M and M′ are acquired. When migration is effected with plural migration voltages and plural fluorescent dyes, all correction factor matrices K are registered.

In a manner similar to the first embodiment, steps S61 to S63 have been performed by the manufacturer side before shipment of the multi-capillary electrophoresis device 500, and the correction factor matrix K has been registered already in the correction factor database 5034. The work actually performed by the operator having purchased the device becomes the next step S64 and onward. Here, it is assumed that, after step S63, the capillaries 519 have been detached and attached at the time of transportation, and the positional relation between the photodetector 504 and the capillaries 519 has changed. When detachment and attachment of the capillaries 519 have not been performed in step S63 and onward, out of the matrices M obtained in step S61, one with a fluorescent dye which is the same as that of migration of the actual sample (step S65) can be selected to be made the matrix M(r)k described below.

In step S64, the operator performs the second spectral calibration in a manner similar to step S11, and the measurement value computation unit 5032 acquires the matrix M(r). Although the migration voltage and the fluorescent dye in step S64 can be made to be the same as those of the first spectral calibration (step S61) as an example, in practice, optional ones can be selected out of those having been registered in the correction factor database 5034.

In step S65, the operator performs migration of the actual sample. Although the migration voltage and the fluorescent dye used here are the same as those of the time of acquisition of the matrix M′ (step S62) as an example, in practice, optional ones can be selected out of those having been registered in the correction factor database 5034.

Since steps S66 to S68 are also similar to steps S13 to S15 (FIG. 9) explained in the first embodiment, explanation thereof will be omitted.

By the operation described above, even when both of the fluorescent dye and the migration voltage to be used may differ between the time of the spectral calibration (step S61) and the time of migration of the actual sample (step S65), the reference spectrum and the fluorescence spectrum of the actual sample do not deviate from each other, and the fluorescence strength of the actual sample is calculated accurately. Although a combination of predetermined fluorescent dye and migration voltage was exemplified here, in practice, the operator can optionally change the migration voltage and the fluorescent dye of the second spectral calibration (step S64) and the actual sample migration (step S65) within a range having been registered in the correction factor database 5034.

### Technical Effect

As described above, in the sixth embodiment, before shipment of the multi-capillary electrophoresis device 500, the first spectral calibration and migration of the actual sample are performed with different migration voltages using a sample labeled by a set of different fluorescent dyes, and the correction factor matrix K for correcting the deviation of the spectrum is acquired for each combination of the fluorescent dye and the migration voltage and is registered in the correction factor database 5034. The operator having purchased the device can perform the second spectral calibration and migration of the actual sample with a combination of optional fluorescent dye and migration voltage having been registered in the correction factor database 5034. Thus, according to the present embodiment, the degree of freedom of the fluorescent dye and the migration voltage used by an operator improves compared to the first to the third embodiments.

### Seventh Embodiment

Although explanation was made on a case where the migration voltage or the fluorescent dye differed between the time of the second spectral calibration and the time of migration of the actual sample in the first to the third embodiments, a case where the chemical property or the composition of the polymer differs will be explained in the seventh embodiment. As described above, since the polymer is only an example of the separation medium, it is needless to mention that same operation can be applied to separation media other than the polymer.

Since the analysis method related to the seventh embodiment can be performed by a flow similar to that of the first embodiment for example, only the different points will be hereinafter explained.

In the seventh embodiment, as an example, the polymer used in the spectral calibration (steps S1 and S11) is to contain 4% of polyacrylamide. Also, the polymer used at the time of migration of the actual sample (steps S2 and S12) is to contain 7% of polyacrylamide. Both of the matrix standard and the actual sample are to be labeled by R6G, R110, TMR, and ROX, and the migration voltage for the both is to be made 15 kV.

As described in the first embodiment, in an actual operation, steps S1 and S2 are performed with combinations of various kinds of the polymer, and plural matrices M and M′ are acquired. The various kinds of the polymer mentioned here means a polymer containing polyacrylamide of various concentrations as an example.

In step S3, the correction factor computation unit 5033 calculates the correction factor matrix K based on the matrices M and M′ . The correction factor matrix K is registered in the correction factor database 5034 along with the information of the kind of the polymer and so on. When migration is effected using plural polymers, all correction factor matrices K are registered.

According to the method of the present embodiment, even when the composition of the polymer may differ between the time of the spectral calibration (step S1) and the time of migration of the actual sample (step S12), the reference spectrum and the fluorescence spectrum of the actual sample do not deviate from each other, and the fluorescence strength of the actual sample is calculated accurately. Although a combination of the predetermined composition was exemplified here, in practice, the operator can optionally change the chemical property of the polymer of the second spectral calibration (step S11) and the actual sample migration (step S12) within a range having been registered in the correction factor database 5034. Further, the method of the present embodiment can be applied also to a case where the composition of the polymer differs.

### Eighth Embodiment

Although explanation was made on a case where the migration voltage or the fluorescent dye differed between the time of the spectral calibration and the time of migration of the actual sample in the first to the third embodiments, a case where the length of the capillaries 519 differs will be explained in the eighth embodiment.

Since the analysis method related to the eighth embodiment can be performed by a flow similar to that of the first embodiment for example, the different points will be hereinafter explained.

In the eighth embodiment, as an example, the capillary length at the time of the spectral calibration (steps S1 and S11) is to be made 50 cm, and the capillary length at the time of migration of the actual sample (steps S2 and S12) is made 36 cm.

As described in the first embodiment, in an actual operation, steps S1 and S2 are performed with combinations of various capillary lengths, and plural matrices M and M′ are acquired.

In step S3, the correction factor computation unit 5033 calculates the correction factor matrix K based on the matrices M and M′ . The correction factor matrix K is registered in the correction factor database 5034 along with the information of the capillary length. When migration is effected with plural capillary lengths, all correction factor matrices K are registered.

According to the method of the present embodiment, even when the capillary length may differ between the time of the spectral calibration (step S1) and the time of migration of the actual sample (step S12), the reference spectrum and the fluorescence spectrum of the actual sample do not deviate from each other, and the fluorescence strength of the actual sample is calculated accurately. Although a combination of the predetermined length was exemplified here, in practice, the operator can optionally change the capillary length of the second spectral calibration (step S11) and the actual sample migration (step S12) within a range having been registered in the correction factor database 5034.

### Ninth Embodiment

Although explanation was made on a case where the migration voltage or the fluorescent dye differed between the time of the spectral calibration and the time of migration of the actual sample in the first to the third embodiments, a case where the composition or the chemical property of the positive pole buffer differs will be explained in the ninth embodiment.

Since the analysis method related to the ninth embodiment can be performed by a flow similar to that of the first embodiment for example, the different points will be hereinafter explained.

In the ninth embodiment, as an example, pH of the positive pole buffer used in the spectral calibration (steps S1 and S11) is to be 7.5. pH of the positive pole buffer at the time of migration of the actual sample (steps S2 and S12) is to be 8.0.

As described in the first embodiment, in an actual operation, steps S1 and S2 are performed with combinations of the positive pole buffer of various pH, and plural matrices M and M′ are acquired.

In step S3, the correction factor computation unit 5033 calculates the correction factor matrix K based on the matrices M and M′ . The correction factor matrix K is registered in the correction factor database 5034 along with the information of pH of the positive pole buffer. When migration is effected using the positive pole buffers of plural pH, all correction factor matrices K are registered.

According to the method of the present embodiment, even when pH of the positive pole buffer may differ between the time of the spectral calibration (step S1) and the time of migration of the actual sample (step S12), the reference spectrum and the fluorescence spectrum of the actual sample do not deviate from each other, and the fluorescence strength of the actual sample is calculated accurately. Although a combination of the predetermined pH of the positive pole buffer was exemplified here, in practice, the operator can optionally change pH of the positive pole buffer of the second spectral calibration (step S11) and the actual sample migration (step S12) within a range having been registered in the correction factor database 5034. Further, the method of the present embodiment can be applied also to a case where the composition of the positive pole buffer differs.

### Tenth Embodiment

Although explanation was made on a case where the chemical property of the positive pole buffer differed in the ninth embodiment, a case where the composition or the chemical property of a negative pole buffer differs will be explained in the tenth embodiment.

In the tenth embodiment, as an example, pH of the negative pole buffer used in the spectral calibration (steps S1 and S11) is to be 7.5. pH of the negative pole buffer at the time of migration of the actual sample (steps S2 and S12) is to be 8.0. Since other points are similar to the ninth embodiment, explanation thereof will be omitted.

According to the method of the present embodiment, even when pH of the negative pole buffer may differ between the time of the spectral calibration (step S1) and the time of migration of the actual sample (step S12), the reference spectrum and the fluorescence spectrum of the actual sample do not deviate from each other, and the fluorescence strength of the actual sample is calculated accurately. Although a combination of the predetermined pH was exemplified here, in practice, the operator can optionally change pH of the positive pole buffer of the second spectral calibration (step S11) and the actual sample migration (step S12) within a range having been registered in the correction factor database 5034. Further, the method of the present embodiment can be applied also to a case where the composition of the negative pole buffer differs.

### Eleventh Embodiment

Although explanation was made on a case where the chemical property of the positive pole buffer differed in the ninth embodiment and a case where the chemical property of the negative pole buffer differed in the tenth embodiment, a case where the chemical property or the composition of a sample solution differs will be explained in the eleventh embodiment.

Since the analysis method related to the eleventh embodiment can be performed by a flow similar to that of the first embodiment for example, the different points will be hereinafter explained.

In the eleventh embodiment, as an example, pH of a solution of the matrix standard used in the spectral calibration (steps S1 and S11) is to be 7.5. pH of a solution of the actual sample used in steps S2 and S12 is to be 8.0.

As described in the first embodiment, in an actual operation, steps S1 and S2 are performed with combinations of the samples of various pH, and plural matrices M and M′ are acquired.

In step S3, the correction factor computation unit 5033 calculates the correction factor matrix K based on the matrices M and M′ . The correction factor matrix K is registered in the correction factor database 5034 along with the information of pH of the sample solution. When migration is effected using the samples of plural pH, all correction factor matrices K are registered.

According to the method of the present embodiment, even when pH of the sample solution may differ between the time of the spectral calibration (step S1) and the time of migration of the actual sample (step S12), the reference spectrum and the fluorescence spectrum of the actual sample do not deviate from each other, and the fluorescence strength of the actual sample is calculated accurately. Although a combination of the sample solution of predetermined pH was exemplified here, in practice, the operator can optionally change pH of the sample solution of the second spectral calibration (step S11) and the actual sample migration (step S12) within a range having been registered in the correction factor database 5034. Further, the method of the present embodiment can be applied also to a case where the composition of the sample solution differs.

### Twelfth Embodiment

In the twelfth embodiment, explanation will be made on a case where the temperature of the constant temperature reservoir 505 differs.

Since the analysis method related to the twelfth embodiment can be performed by a flow similar to that of the first embodiment for example, the different points will be hereinafter explained.

In the twelfth embodiment, as an example, the temperature of the constant temperature reservoir 505 at the time of the spectral calibration (steps S1 and S11) is to be 42° C. Also, the temperature of the constant temperature reservoir 505 at the time of migration of the actual sample (steps S2 and S12) is to be 60° C.

As described in the first embodiment, in an actual operation, steps S1 and S2 are performed with combinations of various temperatures, and plural matrices M and M′ are acquired.

In step S3, the correction factor computation unit 5033 calculates the correction factor matrix K based on the matrices M and M′ . The correction factor matrix K is registered in the correction factor database 5034 along with the information of the temperature of the constant temperature reservoir 505. When migration is effected with the temperature of the constant temperature reservoir 505 being kept at plural temperatures, all correction factor matrices K are registered.

According to the method of the present embodiment, even when the temperature of the constant temperature reservoir 505 may differ between the time of the spectral calibration (step S1) and the time of migration of the actual sample (step S12), the reference spectrum and the fluorescence spectrum of the actual sample do not deviate from each other, and the fluorescence strength of the actual sample is calculated accurately. Although a predetermined combination of the temperature of the constant temperature reservoir 505 was exemplified here, in practice, the operator can optionally change the temperature of the constant temperature reservoir 505 of the second spectral calibration (step S11) and the actual sample migration (step S12) within a range having been registered in the correction factor database 5034.

### On Manifestation

As an example of a method for confirming infringement of the present disclosure, verification described below can be cited. Explanation will be made based on FIG. 9.

In the device of the object, step S11 (spectral calibration) is performed. Although the migration voltage is 15 kV at this time, in practice, the analysis is effected at such migration speed that the migration voltage becomes equivalent to 7.5 kV. The migration speed can be adjusted by adding a salt of an appropriate amount to the sample. Alternatively, while registering the migration voltage to be 15 kV in terms of the device, in practice, migration may be effected with the migration voltage of 7.5 kV. Thereafter, according to the method of the first embodiment, the actual sample is analyzed (steps S13 to S15). At this time, when the pseudo peak increases compared to the time of the first embodiment, it is highly possible that the device of the object has applied the correction factor determined for each migration voltage to the fluorescence spectrum of the matrix standard.

Also, such verification as described below is also possible. Explanation will be made based on FIG. 14. In this case, in step S31, a fluorescent dye different from the actual fluorescent dye is registered. When the pull-up increases compared to the third embodiment after the analysis of the actual sample (steps S34 to S36), it is highly possible that the correction factor determined for each fluorescent dye has been applied to the fluorescence spectrum of the matrix standard.

### Modification

The present disclosure is not limited to the embodiments described above, and includes various modifications. For example, the embodiments described above were explained in detail for easy understanding of the present disclosure, and it is not necessarily required to include all configurations having been explained. Also, a part of an embodiment can be substituted by a configuration of other embodiments. Also, a configuration of an embodiment can be added with a configuration of other embodiments. Further, with respect to a part of the configuration of each embodiment, it is possible to add a part of a configuration of other embodiments, to be deleted, or to be substituted.

Reference Signs List
101... device body,
102...control computer,
103...computation control circuit
104...photodetector,
105...constant temperature reservoir,
106...capillary array,
107...light source,
108...light irradiation unit,
109...load header,
110...negative pole end,
111...negative pole buffer container
112...sample container,
113...polymer cartridge,
114...positive pole buffer container,
115...positive pole,
116...D.C. power source,
117...array header,
118...transporter,
119...capillary,
120...syringe mechanism,
121... sharp point portion,
122...polymer cartridge upper portion,
123...heating/cooling mechanism,
201...laser light,
202...reflection mirror,
203...condenser lens

1. An electrophoresis device, comprising:
an electrophoresis path of a sample;
a dispersion element for dispersing light from the sample within the electrophoresis path;
a photodetector for detecting the light dispersed by the dispersion element; and
a computation unit for determining a spectrum of the light on the basis of a signal from the photodetector, wherein
the computation unit corrects the spectrum using correction factors determined for each electrophoresis condition or fluorescent dye.

2. The electrophoresis device according to claim 1, wherein
the correction factor is determined for each voltage of the time of electrophoresis of the sample.

3. The electrophoresis device according to claim 1, wherein
the correction factor is determined for each pH of a buffer of the time of electrophoresis of the sample or for each pH of a solution of the sample.

4. The electrophoresis device according to claim 1, wherein
the correction factor is determined for each length of the electrophoresis path.

5. The electrophoresis device according to claim 1, further comprising:
a constant temperature reservoir storing the electrophoresis path, wherein
the correction factor is determined for each set temperature of the constant temperature reservoir.

6. The electrophoresis device according to claim 1, wherein
the correction factor is acquired using the predetermined electrophoresis device.

7. The electrophoresis device according to claim 1, wherein
the correction factor is determined for each composition or chemical property of a separation medium within the electrophoresis path.

8. The electrophoresis device according to claim 1, further comprising:
a plurality of the electrophoresis path, wherein
the computation unit sets the correction factor for each of the plurality of the electrophoresis path.

9. The electrophoresis device according to claim 1, wherein
the computation unit calculates a numerical value expressing relative relationship between a first spectrum of a first fluorescent dye and a second spectrum of a second fluorescent dye as the correction factor, and,
by applying the correction factor to a third spectrum of a third fluorescent dye that is the same as the first fluorescent dye, the computation unit corrects the third spectrum according to the relative relationship.

10. The electrophoresis device according to claim 1, wherein
the computation unit calculates a numerical value expressing relative relationship between a first spectrum that is acquired by a first migration condition and a second spectrum that is acquired by a second migration condition as the correction factor, and,
by applying the correction factor to a third spectrum acquired by a third migration condition that is the same as the first migration condition, the computation unit corrects the third spectrum according to the relative relationship.

11. An electrophoresis device, comprising:
an electrophoresis path of a sample;
a dispersion element for dispersing light from the sample within the electrophoresis path;
a photodetector for detecting the light dispersed by the dispersion element; and
a computation unit for calculating signal strength of the light on the basis of a signal from the photodetector, wherein
the photodetector acquires the signal with a signal acquisition width that is set so that a correlation coefficient between spectra of a plurality of fluorescent dye becomes equal to or greater than a predetermined value.

12. An analysis method, comprising:
a step of electrophoresis of a sample in an electrophoresis path;
a step of dispersing light from the sample within the electrophoresis path by a dispersion element;
a step of detecting light dispersed by the dispersion element by a photodetector; and
a step of determining a spectrum of the light on the bases of a signal from the photodetector by a computation unit, wherein
the step of determining a spectrum of the light includes a step of correcting the spectrum by the computation unit using a correction factor determined for each migration condition or fluorescent dye.
